(19) United States
(12) Patent Application Publication
(10) Pub. No.: US 2026/0177617 A1
(43) Pub. Date: Jun. 25, 2026

(54) SYSTEM AND METHODS FOR IOT DEVICE TESTING, PROVISIONING, AND LIFECYCLE MANAGEMENT

(71) Applicant: BOULDER ENGINEERING STUDIO, LLC, BOULDER, CO (US)

(72) Inventors: Jone Evelyn Lay, Boulder, CO (US); Daniel Joseph Bodenstein, Boulder, CO (US); Erin Hensel, Seattle, WA (US); James Matthew Moschella, Boulder, CO (US); Krithik Chandrashekar, Broomfield, CO (US); Alex Lockwood, Seattle, WA (US); Remington Stanley Bullis, Boulder, CO (US)

(21) Appl. No.: 19/427,729

(22) Filed: Dec. 19, 2025

Related U.S. Application Data
(60) Provisional application No. 63/737,370, filed on Dec. 20, 2024.

(51) Int. Cl. G01R 31/319; G06F 8/60; G06F 11/27

(52) U.S. Cl. CPC G01R 31/31905; G06F 8/60; G06F 11/27

(57) ABSTRACT

An Internet-of-Things (IoT) lifecycle management system for testing, provisioning, and managing electronic devices includes an end-of-line (EOL) fixture platform, a device management service, and a secure communication network. The fixture platform comprises modular hardware with at least one device-under-test (DUT) bay, a host computer, and a containerized test runner suite implementing a fixture core framework and GUI application for parallel test execution. A provisioning and identity generation module establishes device identity using physically unclonable functions (PUFs) bonded to tamper-sensitive structures and generates zero-knowledge proof (ZKP) parameters for authentication. The secure communication network enables remote configuration, firmware updates, ownership transfers, and end-of-life decommissioning through blockchain-based attestation and decentralized application (dApp) integration. Additional features include local/remote mode operation, daisy-chaining of fixture platforms, multi-factor PUF provisioning, and incentivized recycling based on cryptographic verification of PUF state changes.

### FIELD OF THE INVENTION

The present disclosure relates to automated systems and methods for testing, provisioning, and lifecycle management of electronic devices, including Internet-of-Things (IoT) devices. More particularly, the disclosure pertains to end-of-line fixture platforms, device management services, and secure communication networks that enable device validation, cryptographic identity provisioning, and lifecycle operations such as secure firmware updates and end-of-life decommissioning.

### RELATED APPLICATION

This application claims priority to U.S. Patent Application No. 63/737,370, titled “System and Methods for IoT Device Testing, Provisioning, and Lifecycle management,” filed Dec. 20th, 2024, and incorporated herein by reference in its entirety.

### BACKGROUND

Modern electronic devices, including Internet-of-Things (IoT) devices, require secure and reliable testing and provisioning during manufacturing to ensure functionality and lifecycle integrity. Conventional end-of-line testing systems lack integrated mechanisms for cryptographic identity provisioning, secure firmware updates, and remote lifecycle management. These limitations create challenges in maintaining device authenticity, enabling secure ownership transfers, and supporting end-of-life decommissioning, particularly in large-scale production environments. The disclosed system addresses these challenges by providing a unified architecture that combines automated testing, modular hardware, containerized software, and advanced security features such as physically unclonable functions (PUFs) and zero-knowledge proofs (ZKPs).

### SUMMARY

The disclosed embodiments provide an integrated system and method for automated testing, secure provisioning, and lifecycle management of electronic devices, including Internet-of-Things (IoT) devices. These embodiments combine modular hardware, containerized software, and advanced cryptographic techniques to streamline end-of-line manufacturing processes, establish hardware-based device identities, and enable secure communication throughout the device's operational life. The architecture supports scalable production environments, remote configuration, authenticated firmware updates, ownership transfers, and end-of-life decommissioning, ensuring device integrity and trust from initial manufacture through recycling.

In certain embodiments, the techniques described herein relate to an end-of-line production fixture platform for testing and provisioning an electronic device, including: a host computer having at least one processor and memory; a physical interface fixture having: at least one device-under-test (DUT) bay configured to receive the electronic device; a suite of measurement and electrical actuation peripherals associated with each DUT bay; and a bay controller for each DUT bay configured to control the electrical actuation peripherals and implement programmable test sequences; a test runner suite stored in the memory and executable by the processor to cause the host computer to: execute at least one test flow on the electronic device received in the at least one DUT bay; manage test resource allocation based on test requirements; validate device-specific test criteria through configurable test modules; and coordinate test operations with other fixture platforms via a network interface; and a fixture gateway stored in the memory and executable by the processor to cause the host computer to: implement bidirectional communication protocols for remote monitoring and configuration; and implement secure firmware deployment.

In certain embodiments, the techniques described herein relate to a system for provisioning an electronic device during manufacturing with tamper-evident hardware-based identity enabling lifecycle management, including: a device provisioning apparatus configured to establish a communication interface with the electronic device for testing and provisioning; at least one processor; memory storing instructions that, when executed by the at least one processor, cause the system to: establish a hardware root-of-trust for the electronic device based on hardware characteristics of the electronic device; integrate root-of-trust validation with tamper-sensitive structures of the electronic device during manufacturing such that tampering with the structures invalidates the root-of-trust, and validate that the tamper-sensitive structures are intact prior to deriving a device identity; derive the device identity from the hardware root-of-trust; provision the electronic device with a device management service configured to: authenticate using the hardware root-of-trust; and communicate with a lifecycle management platform for post-manufacturing operations; and register the device identity with the lifecycle management platform.

In certain embodiments, the techniques described herein relate to an electronic device lifecycle management system, including: an end-of-line production fixture platform configured to: test electronic devices; and provision hardware root-of-trust based device identity during manufacturing; a fixture fleet manager configured to: maintain network connections with a plurality of end-of-line production fixture platforms; synchronize software deployment and configuration across the plurality of end-of-line production fixture platforms; aggregate test results from the plurality of end-of-line production fixture platforms; and provide a management interface for monitoring and controlling the plurality of end-of-line production fixture platforms; a device management service installable on electronic devices, the device management service configured to: authenticate using the hardware root-of-trust; support verification of firmware update authenticity using the hardware root-of-trust; support cryptographic authorization of ownership transfers; and communicate with a secure communication network; and the secure communication network configured to: authenticate devices based on hardware root-of-trust derived identity; maintain lifecycle records; distribute firmware updates to authenticated devices; and process end-of-life decommissioning.

In certain embodiments, the techniques described herein relate to a method for implementing physically unclonable function (PUF) bonding in an electronic device, including: identifying physical structures within or attached to the electronic device suitable for PUF measurement, wherein the physical structures serve functional purposes in operation of the electronic device; measuring unique physical characteristics of the identified physical structures using one or more of: optical imaging, optical imperfection analysis, capacitive sensing, time-domain reflectometry, acoustic resonance measurement, radio-frequency spectral analysis, thermal response profiling, piezoelectric response characterization, or surface texture analysis; integrating PUF measurement circuits with the identified physical structures such that tampering with the physical structures irreversibly alters PUF measurements; deriving a device identity from the PUF measurements; and registering the device identity with a lifecycle management platform.

### BRIEF DESCRIPTION OF THE FIGURES

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram illustrating one example Internet-of-Things (IoT) lifecycle management system for testing, provisioning, and lifecycle management of an IoT device, in embodiments.

FIG. 2 is a schematic diagram illustrating the EOL production fixture platform of FIG. 1 in further example detail, in embodiments.

FIG. 3 is a schematic diagram illustrating example software architecture of the fixture platform of FIG. 1 in further example detail, in embodiments.

FIG. 4 is a schematic diagram showing further example detail of the fixture core framework illustrating implemented functionality, including result data structures and status tracking, in embodiments.

FIG. 5 is a schematic diagram illustrating one example build process for generation of test runner suite 108, in embodiments.

FIGS. 6A, 6B, and 6C are flowcharts illustrating one example method, and its subroutines, for test cycle execution of the fixture platform of FIG. 1, in embodiments.

FIG. 7 is a sequence diagram illustrating a DUT test sequence showing interactions between the fixture core framework, bay controller, and DUT during test execution, in embodiments.

FIG. 8 is a block diagram illustrating the modular hardware architecture of the EOL production fixture platform, showing relationships between DUT bays, bay controllers, control boards, bay controller interfaces, host computer, and fixture gateway, in embodiments.

FIG. 9 is an assembly diagram illustrating internal arrangement of the hardware elements in the lower assembly of the EOL production fixture platform of FIG. 2, in embodiments.

FIG. 10 is an assembly diagram illustrating internal arrangement of the EOL production fixture with modular IO modules attached within the lower assembly of the fixture platform of FIG. 2, in embodiments.

FIG. 11 is an assembly diagram illustrating a DUT bay configuration for receiving a single small-form-factor electronic device, in embodiments.

FIG. 12 is an assembly diagram illustrating a DUT bay configuration for receiving two small-form-factor electronic devices in parallel, in embodiments.

FIG. 13 is an assembly diagram illustrating a DUT bay configuration for receiving three small-form-factor electronic devices in parallel, in embodiments.

FIG. 14 is an assembly diagram illustrating a DUT bay configuration for receiving a single medium-form-factor electronic device, in embodiments.

FIG. 15 is an assembly diagram illustrating a DUT bay configuration for receiving two medium-form-factor electronic devices in parallel, in embodiments.

FIG. 16 is an assembly diagram illustrating a DUT bay configuration for receiving a single large-form-factor electronic device, in embodiments.

FIG. 17 is an assembly diagram illustrating daisy-chain electrical connections between control boards of adjacent fixture platforms, in embodiments.

FIG. 18 is an assembly diagram illustrating a complete daisy-chained assembly comprising multiple fixture platforms monitored from a single host computer, in embodiments.

FIG. 19 is a data flow diagram illustrating one example sequence for provisioning the DUT of FIG. 1, in embodiments.

FIG. 20 is a schematic diagram illustrating example provisioning of the DUT of FIG. 1 with a device PUF root-of-trust, in embodiments.

FIG. 21 is a schematic diagram illustrating the dual MCU-architecture and PUF sensor interface of the DUT, in embodiments.

### DETAILED DESCRIPTION OF THE EMBODIMENTS

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with sensors, computers, processors (hardware processors), memory, or other storage have not been shown or described in detail to avoid unnecessarily obscuring descriptions of the various implementations and embodiments.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one implementation” or “an implementation” or “one embodiment” or “an embodiment” means that a particular feature, structure or characteristic described in connection with the embodiment is included in at least one implementation or embodiment. Thus, the appearances of the phrases “one implementation” or “an implementation” or “in one embodiment” or “in an embodiment” in various places throughout this specification are not necessarily all referring to the same implementation or embodiment. Furthermore, the particular features, structures, or characteristics may be combined in any suitable manner in one or more implementations or one or more embodiments.

As used in this specification, any appendices thereto, and the appended claims, the singular forms “a,” “an,” and “the” include plural referents unless the content clearly dictates otherwise. It should also be noted that the term “or” is generally employed in its sense including “and/or” unless the content clearly dictates otherwise.

### IoT Lifecycle Management System

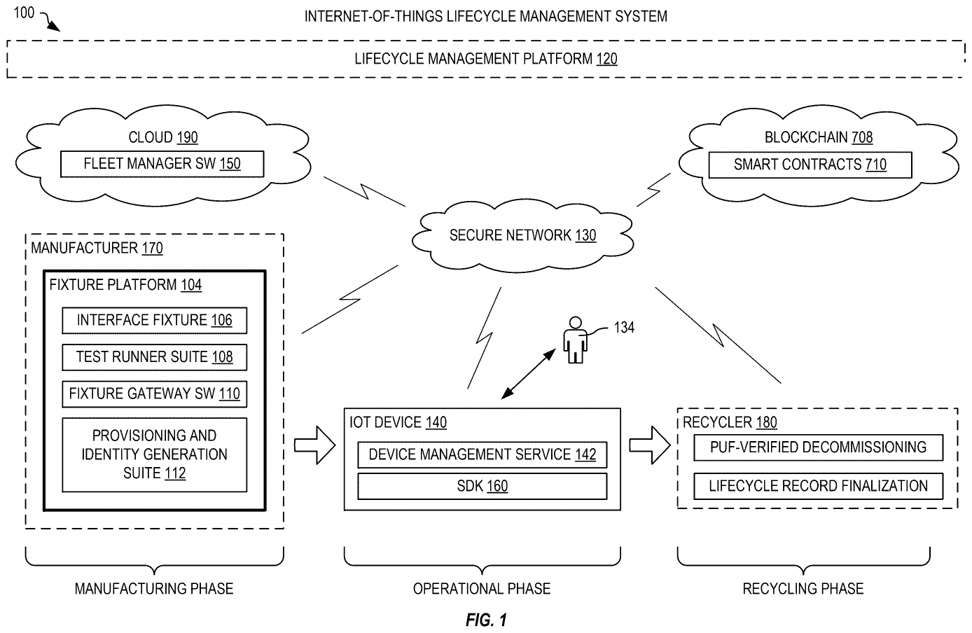

FIG. 1 is a schematic diagram illustrating one example Internet-of-Things (IoT) lifecycle management system 100 for testing, provisioning, and lifecycle management of a device 140 (e.g. an IoT device or similar device that includes electronic circuitry such as memory and/or a processor or microcontroller), in embodiments. Device 140 may be referred to as a device-under-test (DUT) hereafter. IoT lifecycle management system 100 includes manufacturer 170 operating EOL production fixture platform 104, DUT 140 incorporating device management service 142 and device SDK 160, a secure communication network 130, lifecycle management platform 120, owner 134, and recycler 180. Cloud 190 may host fixture fleet manager 150 for centralized management of EOL production fixture platforms 104. DUT 140 represents any electronic device that may be tested and provisioned on EOL production fixture platform 104.

EOL production fixture platform 104 includes IoT device physical interface fixture 106, test runner suite 108, fixture gateway software 110, and a provisioning and identity generation suite 112. These components may operate cooperatively to test and provision DUT 140 during manufacturing.

The present embodiments provide IoT lifecycle management system 100 for IoT device testing, provisioning, and lifecycle management. IoT lifecycle management system 100 includes a manufacturer 170 operating an end-of-line (EOL) production fixture platform 104, a device management service 142 deployed on DUT 140, and secure communication network 130. IoT lifecycle management system 100 may further include cloud 190 hosting fixture fleet manager 150 for centralized management of multiple EOL production fixture platforms 104. The following description uses an IoT device as an example; however, the IoT device could be any electronic device that may be tested and provisioned on EOL production fixture platform 104.

The EOL production fixture platform includes IoT device physical interface fixture 106, a test runner suite 108, a fixture gateway software 110, and provisioning and identity generation suite 112 that work together to streamline the testing and validation of IoT devices during manufacturing and enable additional communication, device management, and network capabilities.

IoT device physical interface fixture 106 is a modular hardware solution that provides the physical interface for testing DUT 140 test runner suite 108, which executes on host computer 210 as part of fixture core framework 212, facilitates concurrent and sequential test flows, remote configuration, and integration with a wide range of testing modules, including circuit testing, power supply validation, and communication protocol verification. The fixture platform's adaptability and robustness enable devices under test to be subjected to thorough testing and validation before deployment.

The test runner suite 108 includes the reusable fixture core framework 212, a reusable GUI component library, and project specific code that uses the fixture core framework to carry out operations specific to a project. The test runner suite 108 provides a user-friendly interface for fixture operators to manage the testing process, including features such as barcode tracking, visual result feedback, and test result reporting. The fixture core framework may be configured to support various workflows and fixture roles, allowing it to adapt to different project requirements and production line setups.

Fixture fleet manager 150 is a management service that enables remote monitoring, control, and configuration of fixture platforms. In some embodiments, fixture fleet manager 150 may be hosted on Cloud 190. Fixture fleet manager 150 allows users to manage individual fixture platforms or entire fleets of fixture platforms, updating test parameters, fixture roles, and facilitating remote updates as needed. Instances of fixture gateway software 110 connect to fixture fleet manager 150 via Cloud 190 to report their status and receive commands.

Device management service 142 is software that is installed into DUT 140 by EOL production fixture platform 104 to enable secure communication between DUT 140 and secure communication network 130 for lifecycle management. In certain embodiments, device management service 142 is developed using device SDK 160, which provides a device-side foundation for developing firmware and software for IoT devices and other embedded devices, allowing DUT 140 to securely connect to and communicate with secure communication network 130. Device SDK 160 is distinct from Core SDK 162 of fixture core framework 212, which is used for developing test procedures and fixture configurations. Device management service 142 includes code for communicating with fixture core framework 212 to establish device identity and authenticity with associated IoT services, as well as code that facilitates device-side secure firmware updates, ownership transfer, and end-of-life decommissioning. In certain embodiments, device management service 142 supports secure ownership transfer with cryptographic verification of transfer authorization and credential updates upon ownership transfer. By integrating this programming and test fixture architecture during manufacturing device SDK 160 and similar provisioning tooling may be deployed into DUT 140.

The Provisioning and Identity Generation Suite incorporates advanced security features, such as Physically Unclonable Functions (PUFs) for unique device identity provisioning and Zero-Knowledge Proofs (ZKPs) for privacy-preserving authentication, within the fixture testing and fixture gateway software 110 context. Integrating PUF and ZKP features into the EOL testing process of IoT lifecycle management system 100 enables application of these security mechanisms across device lifecycle stages, including manufacturing by EOL production fixture platform 104, operational authentication via secure communication network 130, ownership transfer, and end-of-life decommissioning.

Secure communication network 130 facilitates the network side functionality of secure firmware updates, ownership transfer, and end-of-life decommissioning, maintaining the integrity and security of DUT 140 throughout its entire lifespan. This infrastructure enables coordinated management of devices and fixtures through network-accessible interfaces for configuration updates, test result reporting, and operational data analysis. Additional network-based functions include centralized and decentralized data endpoints, smart contract based device management, comprehensive data auditability, and fleet-wide device monitoring and control.

The IoT lifecycle management system 100 integrates the EOL production fixture platform 104, device management service 142, and secure communication network 130 into a unified architecture that enables automated testing, remote configuration, and cryptographic device provisioning during manufacturing. This integration establishes a foundation for fleet-wide fixture management, secure firmware updates throughout device operation, and authenticated ownership transfers, creating a complete framework from manufacturing through end-of-life decommissioning.

IoT device physical interface fixture 106 is a modular hardware assembly containing DUT bays 202 configured to receive DUT 140 for testing and provisioning. Test runner suite 108 is software that executes on host computer 210 as part of fixture core framework 212 and facilitates concurrent and sequential test flows, remote configuration, and integration with testing modules. Test runner suite 108 includes fixture controller 214 for hardware interface abstraction and fixture procedure 216 for test execution logic. Testing modules may include circuit testing, power supply validation, and communication protocol verification, among others. This architecture enables DUT 140 to undergo functional testing and validation prior to deployment.

In embodiments, EOL production fixture platform 104 implements comprehensive validation procedures that subject DUT 140 to functional testing, electrical characterization, and communication protocol verification as required by production specifications before deployment. The modular architecture may allow EOL production fixture platform 104 to be configured with project-specific test modules, enabling adaptation to different device types and manufacturing requirements without requiring redesign of the core platform. In certain embodiments, EOL production fixture platform 104 validates both hardware functionality and provisioned security credentials, ensuring that DUT 140 meets operational requirements and security standards prior to release from the manufacturing facility.

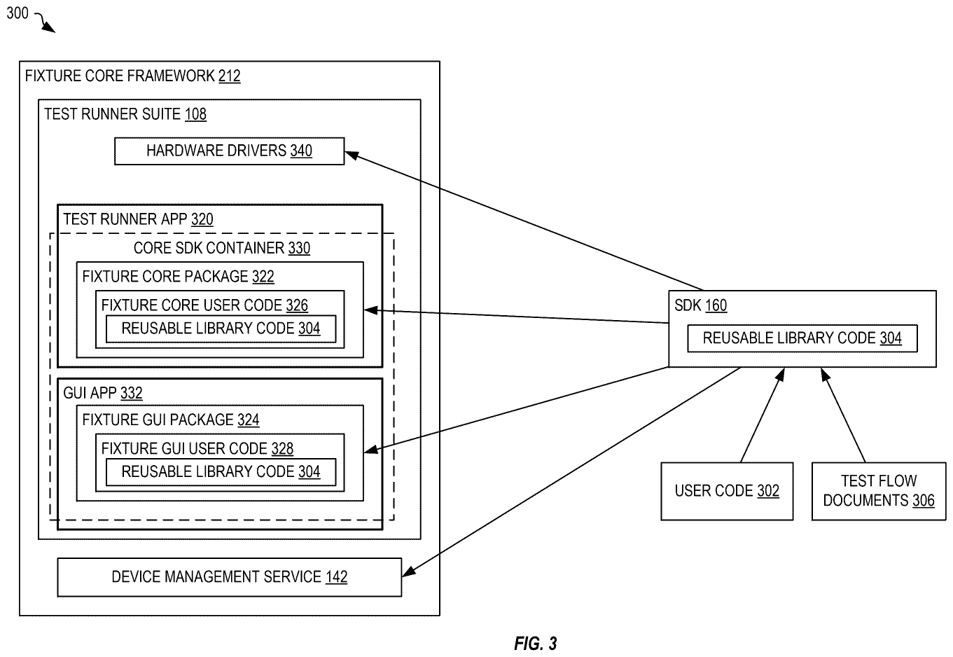

Test runner suite 108 includes fixture controller 214 and fixture procedure 216, which operate within fixture core framework 212 on host computer 210. Test runner application 320 and GUI application 332 (see FIG. 3) allow an operator of EOL production fixture platform 104 to manage the testing process, including features such as barcode tracking, visual result feedback, and test result reporting. Fixture controller 214 provides hardware abstraction for communicating with bay controller 204 and bay controller firmware 222. Fixture procedure 216 defines test operations that utilize fixture controller 214 to perform measurements and actuations on DUT 140. Test runner suite 108 may be configured to support various workflows and fixture roles, allowing it to adapt to different project requirements and production line setups. For example, test runner suite 108 may perform a plurality of fixture procedures in parallel across multiple DUT bays 202 while maintaining independent bay-specific test flows. Test runner suite 108 manages test resource allocation based on test requirements, including assignment of measurement peripherals, communication interfaces, and processing capacity to active test operations across available DUT bays 202.

Fixture gateway software 110 enables remote monitoring, control, and configuration of EOL production fixture platform 104, supporting both local and remote modes of operation for flexibility. In certain embodiments, fixture gateway software 110 includes a fleet manager interface configured to communicate with fixture fleet manager 150 to synchronize software deployment, firmware updates, and configuration across multiple fixture platforms. For example, fixture gateway software 110 allows users to manage individual fixture platforms or entire fleets of fixture platforms, updating test parameters, fixture roles, and facilitating remote updates as needed. Fixture gateway software 110 supports both local and remote modes of operation, providing flexibility in deployment and management.

In certain embodiments, fixture gateway software 110 implements user and operator access control mechanisms that regulate permissions for configuration changes, test execution, and data access based on defined roles and authentication credentials. The software architecture may enable code written for testing a single DUT to scale automatically to multi-DUT fixtures, often without modification, by abstracting bay-specific operations from core test logic. In embodiments, fixture gateway software 110 provides integration modules for enterprise resource planning (ERP) systems, enabling bidirectional data exchange between EOL production fixture platform 104 and manufacturing execution systems. These integration modules may facilitate automated work order tracking, inventory management synchronization, and production metrics reporting. Fixture gateway software 110 may support both local and remote modes of operation, providing flexibility in deployment and management across diverse manufacturing environments and organizational structures.

Provisioning and identity generation suite 112 may be software that implements tools and algorithms that incorporate advanced security features, such as physically unclonable functions (PUFs) for unique device identity provisioning and zero-knowledge proofs (ZKPs) for privacy-preserving authentication, within the fixture testing and fixture gateway software 110 context. In embodiments, provisioning and identity generation suite 112 supports strong PUF provisioning for challenge-response authentication, weak PUF provisioning for direct key generation, multi-factor PUF provisioning, and PUF bonding for tamper resistance.

By integrating these features into an EOL testing process of IoT lifecycle management system 100, the applicability of PUFs and ZKPs may be expanded throughout device lifecycle management. In certain embodiments, provisioning and identity generation suite 112 prevents duplication or spoofing of any identity or role assigned to DUT 140 during manufacture by cryptographically binding device identity to unique physical characteristics that cannot be cloned or reproduced. The PUF-based provisioning may establish a hardware root-of-trust that persists throughout the device lifecycle, enabling authentication of DUT 140 during operational phases and end-of-life processing. In embodiments, zero-knowledge proof integration allows verification of device authenticity and state without exposing sensitive identifying material, providing privacy-preserving authentication while maintaining auditability. This cryptographic foundation may enable secure ownership transfers, authenticated firmware updates, and verifiable end-of-life decommissioning as described further herein. As used herein, ‘hardware root-of-trust’ refers to a cryptographic foundation derived from hardware characteristics of a device, including but not limited to physically unclonable function (PUF) measurements, secure element attestations, or other hardware-based identity mechanisms.

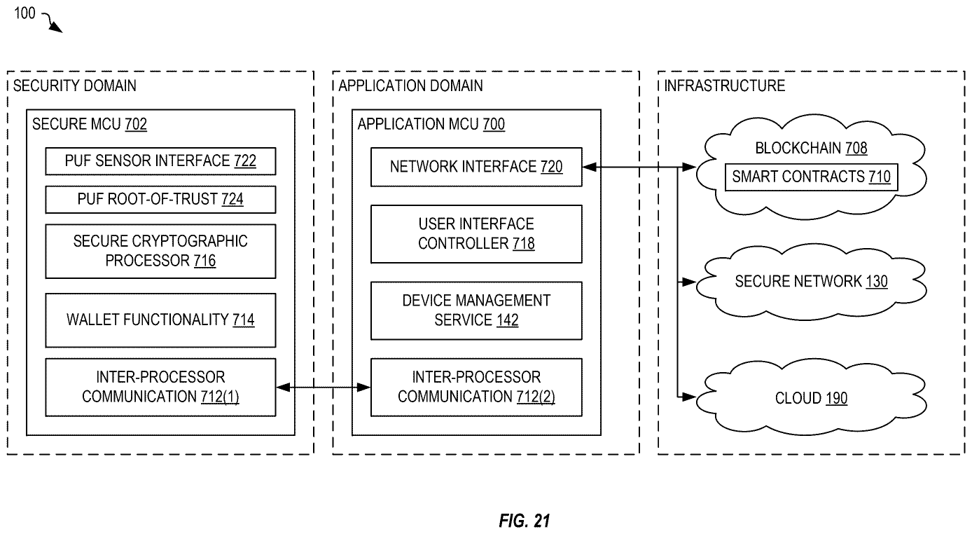

Device management service 142 is software (e.g., firmware) that is installed into DUT 140 by EOL production fixture platform 104 to enable secure communication between DUT 140 and secure communication network 130 for lifecycle management. In certain embodiments, DUT 140 includes device SDK 160, which provides a foundation for developing firmware and software of device management service 142 for DUT 140 and other embedded devices, allowing DUT 140 to securely connect to and communicate with secure communication network 130. In embodiments utilizing a dual-MCU architecture (see, e.g., FIG. 21) device management service 142 executes on application MCU 700 of DUT 140, interfacing with secure MCU 702 for cryptographic operations and with network interface 720 for communication with smart contracts 710 on blockchain 708. Alternative embodiments may implement device management service 142 on a single microcontroller or system-on-chip without departing from the scope hereof. Device management service 142 facilitates secure firmware updates, ownership transfer, and end-of-life decommissioning, maintaining the integrity and security of DUT 140 throughout its lifecycle from manufacturing by manufacturer 170, through operation by owner 134, to recycling by recycler 180. Fixture core framework 212 includes components operable to deploy device management service 142 to DUT 140 through one or more communication pathways, utilizing fixture controller 214 for hardware interface abstraction. In certain embodiments, device management service 142 incorporates customizations developed using device SDK 160.

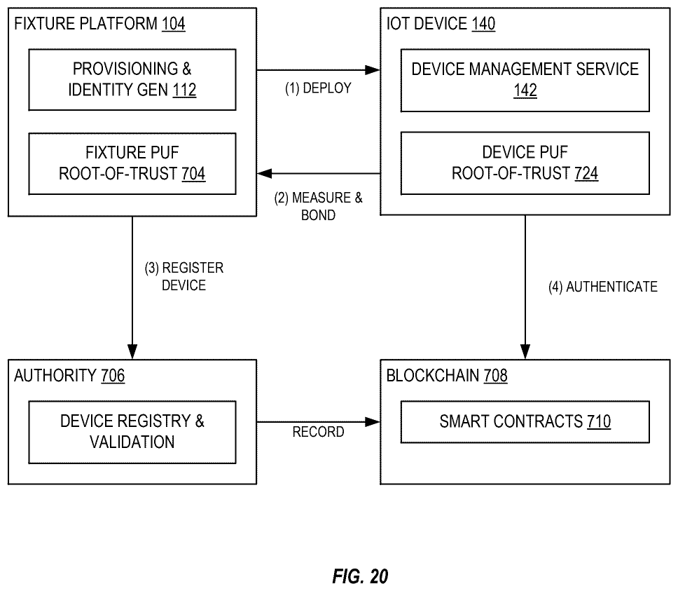

Secure communication network 130 facilitates secure firmware updates for DUT 140, ownership transfer for DUT 140, and end-of-life decommissioning of DUT 140, by maintaining the integrity and security of DUT 140 throughout its entire lifespan. For example, secure communication network 130 and device management service 142 facilitate outdated firmware detection and may generate a corresponding alert. In certain embodiments, secure communication network 130 supports a decentralized architecture, blockchain integration, and smart contract-based device management for enhanced auditability and trust. This allows DUT 140 and its owner 134 to take advantage of the features and functions listed above, and additionally enable DUT 140 and/or EOL production fixture platform 104 to be managed, updated, studied, and produced more efficiently through various tools, including test result reporting and analysis. For example, secure communication network 130 and device management service 142 facilitate automated lifecycle state transition recording on a distributed ledger (e.g., on blockchain 708 of FIG. 20). In certain embodiments, secure communication network 130 includes a distributed ledger interface configured to record device attestation events on blockchain 708 and verify ownership transfers through smart contract integration. Additional network based functions include centralized and decentralized data endpoints, smart contract-based device management, enhanced data auditability and enhanced fleet management.

In certain embodiments, Cloud 190 provides hosted infrastructure for fixture fleet manager 150 and related services. In certain embodiments, fixture fleet manager 150 executes on Cloud 190 and communicates with fixture gateway software 110 on each EOL production fixture platform 104 to enable centralized monitoring, configuration, and software deployment. API module 501 of fixture core framework 212 provides connectivity to Cloud 190, enabling fixture fleet manager 150 to access operational data and issue commands to EOL production fixture platforms 104. In certain embodiments, Cloud 190 also hosts components of secure communication network 130 for device lifecycle management.

In certain embodiments, secure communication network 130 interfaces with Cloud 190 to provide scalable backend services for device lifecycle management. Cloud 190 may host one or more of: blockchain 708 nodes, smart contract 710 execution environments, device registry databases, firmware distribution servers, and analytics platforms. Cloud 190 enables secure communication network 130 to provide high-availability services accessible from geographically distributed manufacturing facilities and deployed devices. In certain embodiments, Cloud 190 implements redundant storage and processing to ensure continuous availability of lifecycle management services.

Lifecycle management platform 120 represents a service for managing the lifecycle of DUT 140 from manufacturing through end-of-life decommissioning. Lifecycle management platform 120 may be implemented as a third-party service, an internal enterprise system, or a component of secure communication network 130. In certain embodiments, lifecycle management platform 120 maintains device registry records, tracks ownership transfers, coordinates firmware update distribution, and processes end-of-life decommissioning requests. Lifecycle management platform 120 may interface with blockchain 708 and smart contracts 710 to provide decentralized verification of device lifecycle state transitions.

IoT lifecycle management system 100 combines hardware and software components to implement automated testing, centralized management of EOL activities through fixture fleet manager 150, end-to-end lifecycle management via secure communication network 130 and device management service 142, and security provisioning through provisioning and identity generation suite 112. This architecture enables configuration for varying production requirements, scaling across multiple EOL production fixture platforms 104 through fixture gateway software 110, and secure provisioning of DUT 140.

### Parallel Scaling Software and Hardware Architecture for Device Testing During Production

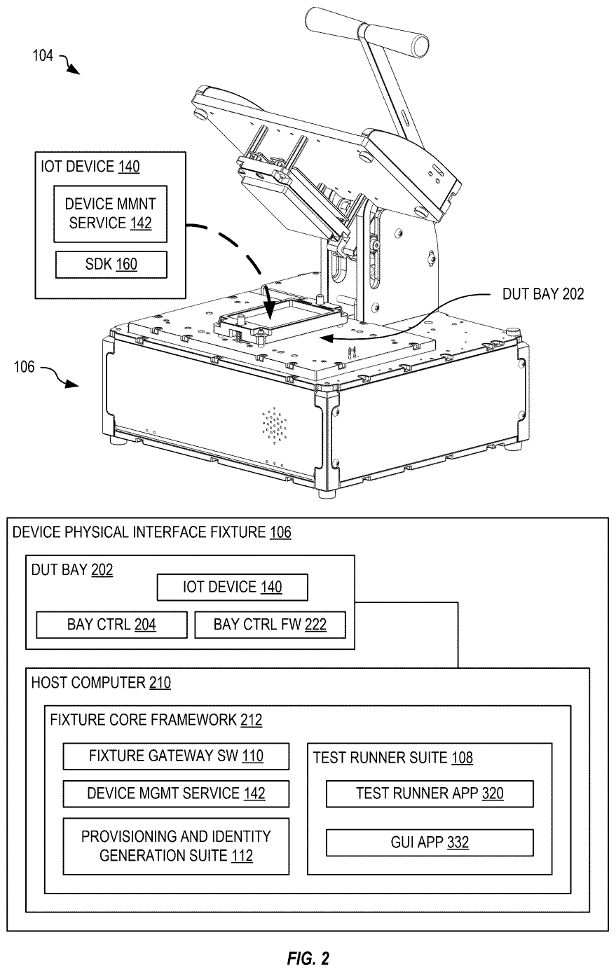

FIG. 2 shows EOL production fixture platform 104 of FIG. 1 in further example detail, in embodiments. EOL production fixture platform 104 includes IoT device physical interface fixture 106 containing a number of device-under-test (DUT) bays 202 that each receive one DUT 140 during production. In certain embodiments, each DUT bay 202 includes a bay controller 204 with bay controller firmware 222 for controlling test operations. Host computer 210 executes fixture core framework 212, which includes test runner suite 108, fixture gateway software 110, and provisioning and identity generation suite 112. DUT 140 includes device management service 142 and device SDK 160 for lifecycle management operations. FIG. 3 is a schematic diagram illustrating software architecture 300 of EOL production fixture platform 104 in further example detail, in embodiments. FIGS. 2 and 3 are best viewed together with the following description. IoT device and DUT are used interchangeably here to refer to the device received by the DUT bay 202 for testing and provisioning.

In certain embodiments, bay controller firmware 222 executes on bay controller 204 and provides low-level control of measurement and actuation peripherals within each DUT bay 202. Bay controller firmware 222 receives commands from fixture core framework 212 via fixture controller 214 and returns measurement data and status information. In certain embodiments, bay controller firmware 222 implements real-time control loops for precise timing of test operations. Bay controller firmware 222 may be updated through fixture gateway software 110 to support new test capabilities or address operational issues.

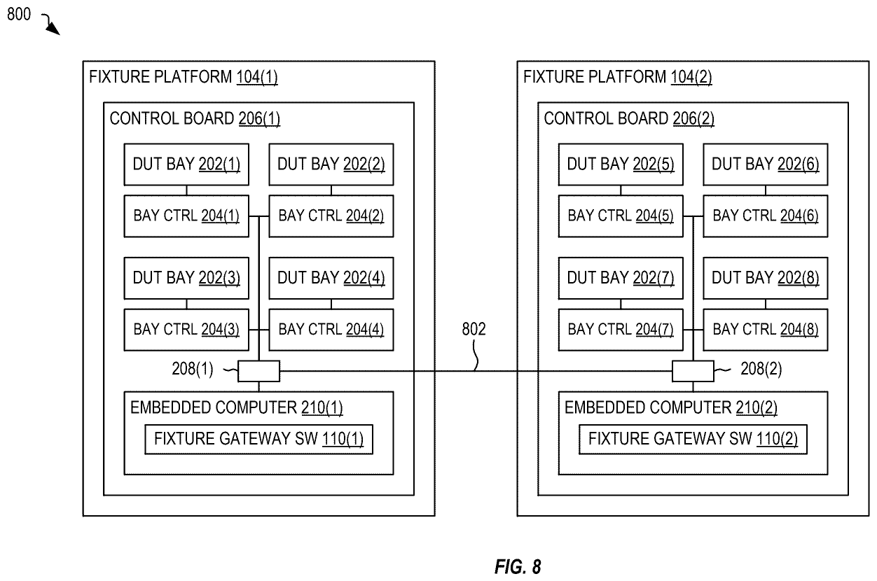

In this example, EOL production fixture platform 104 is shown with a single DUT bay 202; however, EOL production fixture platform 104 may have multiple DUT bays 202 of various sizes and configurations without departing from the scope hereof, as illustrated in FIGS. 8 and 11-16. EOL production fixture platform 104 includes a host computer 210 comprising at least one processor and memory storing machine-readable instructions executable by the processor. Host computer 210 may be implemented as a single board computer, a laptop computer, a desktop computer, or other computing device capable of executing fixture core framework 212. Fixture core framework 212 executes on host computer 210 and includes test runner suite 108, fixture gateway software 110, and provisioning and identity generation suite 112. Test runner suite 108 includes fixture controller 214 for hardware interface abstraction and fixture procedure 216 for test execution logic. DUT bay 202 has a bay controller 204 with bay controller firmware 222 that controls a suite of measurement and electrical actuation peripherals configurable for desired measurements and electrical actuations of DUT 140 when positioned within DUT bay 202. In embodiments with multiple DUT bays, each DUT bay 202 has an associated bay controller 204. Bay controller 204 may be implemented as one or more of a hardware microcontroller unit (MCU), a soft-core of host computer 210, and/or handled directly by host computer 210.

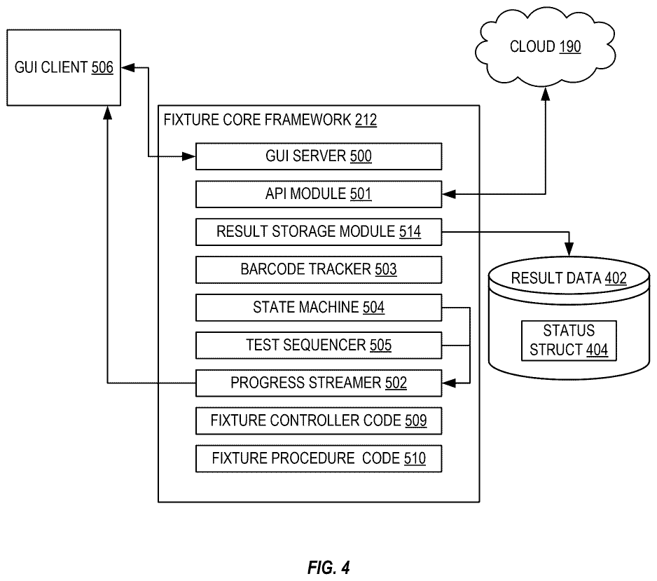

FIG. 4 illustrates fixture core framework 212 in further detail, in embodiments. Fixture core framework 212 includes functional components for managing test operations, operator interaction, and data handling. Fixture core framework 212 incorporates Core SDK 162 that provides reusable libraries, hardware abstractions, and development tools for creating test procedures and fixture configurations. Core SDK 162 is distinct from device SDK 160, which is used for developing firmware deployed to DUT 140. In various embodiments, fixture core framework 212 includes one or more of: GUI server 500 that enables GUI client 506 to connect to fixture core framework 212 for operator interaction; API module 501, such as a REST API, that enables network-based control over the state of fixture core framework 212 and provides connectivity to Cloud 190 for integration with fixture fleet manager 150; progress streamer 502 that transmits test progress updates to GUI client 506; barcode tracker 503 that tracks devices scanned by an operator; state machine 504 that maintains and enables changes to the operational state of fixture core framework 212 including current configuration and active test cycles; test sequencer 505 that executes configured test flows across DUTs 140 specified by the operator when a test cycle is initiated; fixture controller source code 509 defining hardware interface abstractions; fixture procedure source code 510 defining test operations; and result storage module 514 that stores test results to result data 402 including status structure 404. GUI client 506 communicates bidirectionally with progress streamer 502 to receive real-time test progress updates and transmit operator commands.

In certain embodiments, GUI server 500 communicates via websocket, HTTP, or other network protocols. In certain embodiments, barcode tracker 503 identifies devices through barcode scanning, radio-frequency identification (RFID), manual entry, or other identification mechanisms. The functional components of fixture core framework 212 may be implemented as software modules, firmware, hardware, or any combination thereof.

FIG. 3 illustrates software architecture 300 of EOL production fixture platform 104, in embodiments. Software architecture 300 includes fixture core framework 212, Core SDK 162, user code 302, and test flow documents 306. Fixture core framework 212 includes device management service 142 for deployment to DUT 140, and test runner suite 108 with hardware driver 340 for interfacing with bay controller 204. Test runner suite 108 further includes a core SDK container 330, which contains test runner application 320 and GUI application 332. Test runner application 320 includes fixture core package 322, which contains fixture core user code 326 incorporating reusable library code 304. GUI application 332 contains fixture GUI package 324, which includes fixture GUI user code 328 incorporating reusable library code 304. Core SDK 162 includes reusable library code 304, which provides common data structures and communication protocols. In certain embodiments, device SDK 160 accesses reusable library code 304 from Core SDK 162 for device-side development, enabling consistent interfaces between firmware executing on DUT 140 and EOL production fixture platform 104. User code 302 and test flow documents 306 define project-specific test logic and sequencing and interface with Core SDK 162.

Test runner application 320 coordinates test execution according to test flow documents 306 and user code 302. Core SDK container 330 provides the runtime environment for fixture controller 214 and fixture procedure 216. GUI application 332 provides operator interface capabilities through fixture GUI package 324. Fixture GUI user code 328 defines project-specific interface customizations utilizing reusable library code 304. In certain embodiments, reusable library code 304 is shared between device SDK 160 deployed on DUT 140 and fixture GUI package 324 executing on host computer 210, enabling consistent data structures and communication protocols between EOL production fixture platform 104 and DUT 140.

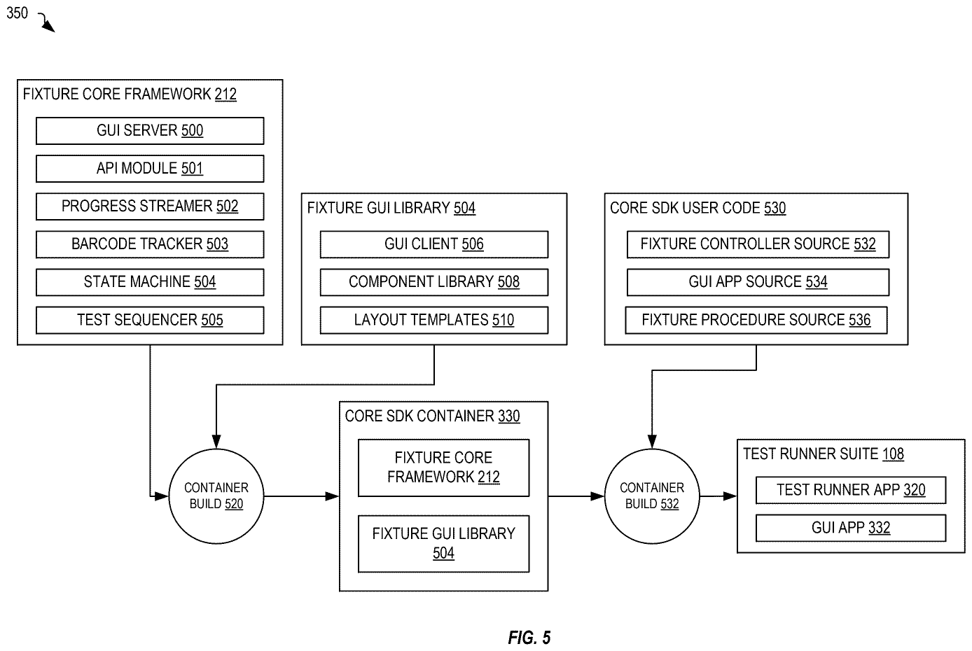

FIG. 5 illustrates one example build process 350 for generation of test runner suite 108, in embodiments. Build process 350 includes a core SDK build process and a test runner build process that combine fixture core framework 212, user code 302, and test flow documents 306 to produce deployable software components. The Core SDK 162 build process generates core SDK container 330 containing test runner application 320 and GUI application 332. Test runner application 320 includes fixture core package 322 with fixture controller 214 and fixture procedure 216. The test runner build process incorporates core SDK container 330 with project-specific user code 302 and test flow documents 306 to produce the deployable software for host computer 210. Build process 350 enables reuse of fixture core framework 212 across multiple projects while allowing project-specific customization through user code 302 and fixture core user code 326.

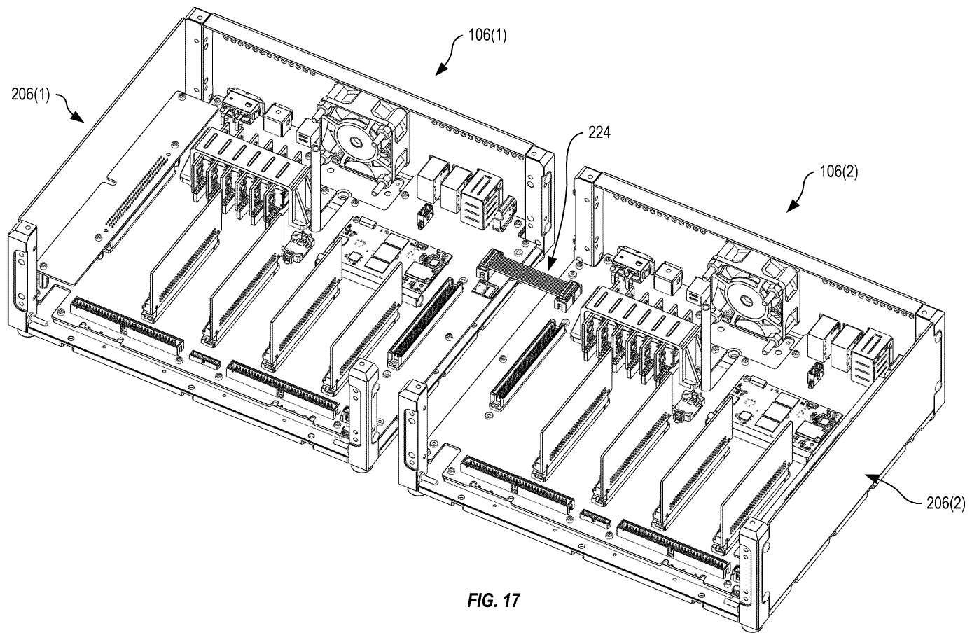

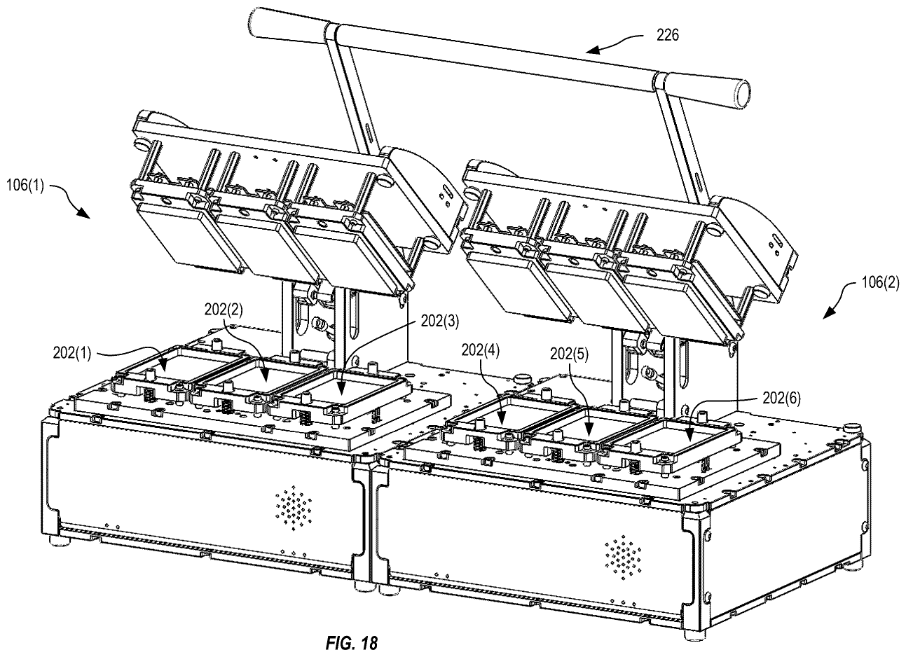

FIG. 17 demonstrates how multiple fixtures may be “daisy chained” together via daisy-chain electrical interface 224 between control boards 206 in order to expand the number of DUT bays 202 available for testing, while still being monitored from a single operating system. FIG. 18 illustrates a complete daisy-chained assembly comprising multiple EOL production fixture platforms 104 connected in series via daisy-chain mechanical coupling 226, with a single host computer 210 providing unified monitoring and control across all connected fixture platforms.

Bay controller 204 includes a control board architecture that supports attachment of modular input/output (IO) boards for expansion of peripheral connectivity beyond standard IO ports. Modular IO boards may include, but are not limited to, additional power supplies, specialty connectors, antennas, communication interfaces, sensor modules, and signal conditioning circuits. In certain embodiments, modular IO boards provide additional serial interfaces such as UART, SPI, or I2C. In certain embodiments, modular IO boards provide wireless communication capabilities such as Wi-Fi, Bluetooth, Zigbee, or cellular connectivity. In certain embodiments, modular IO boards provide analog-to-digital conversion, digital-to-analog conversion, or programmable logic interfaces. The modular IO board architecture enables EOL production fixture platform 104 to be configured for diverse testing requirements without modification to bay controller 204.

FIG. 8 is a block diagram illustrating the modular architecture of EOL production fixture platform 104, in embodiments. FIG. 8 illustrates multiple EOL production fixture platforms 104(1) and 104(2) operating in a manufacturing environment. Each EOL production fixture platform 104 includes a control board 206 with bay controller interface 208 connecting to host computer 210 executing fixture gateway software 110. Bay controller interface 208 further connects to multiple bay controllers 204, each controlling a corresponding DUT bay 202. As shown in FIG. 8, EOL production fixture platform 104(1) includes control board 206(1) with bay controller interface 208(1) connecting to host computer 210(1) and bay controllers 204(1) through 204(4), each with corresponding DUT bays 202(1) through 202(4). Similarly, EOL production fixture platform 104(2) includes control board 206(2) with bay controller interface 208(2) connecting to host computer 210(2) and bay controllers 204(5) through 204(8), each with corresponding DUT bays 202(5) through 202(8). This modular architecture enables independent operation of each DUT bay 202 while maintaining centralized control and monitoring through host computer 210 and remote management through fixture gateway software 110.

In certain embodiments, EOL production fixture platform 104 accommodates a drop-in modular power entry module to provide AC power directly to DUT bays 202 for testing. In certain embodiments, the power entry module includes power conditioning, filtering, or voltage conversion circuitry. In certain embodiments, EOL production fixture platform 104 accommodates alternative power entry configurations including DC power input, Power over Ethernet (PoE), or battery power for portable or remote deployment scenarios.

### Internal Assembly and Modular Hardware Architecture

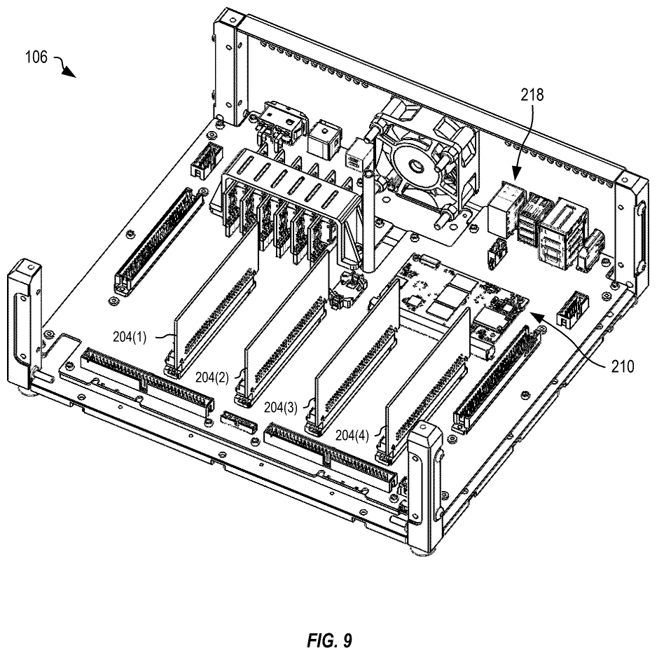

FIG. 9 is an assembly diagram illustrating internal arrangement of the control board within the lower assembly of EOL production fixture platform 104, in embodiments. The lower assembly houses bay controller 204 and associated electronics that interface with DUT bays 202. In certain embodiments, the control board is mounted to provide thermal management and electrical isolation from DUT 140 during testing. The control board architecture includes mounting points for expansion modules and cable routing channels for peripheral connections.

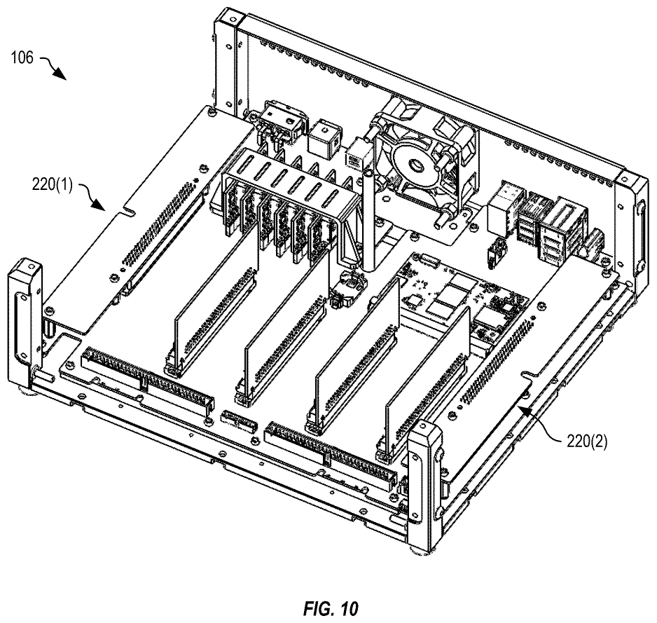

FIG. 10 is an assembly diagram illustrating internal arrangement of the control board with modular IO boards attached within the lower assembly of EOL production fixture platform 104, in embodiments. Bay controller 204 includes a control board architecture that supports attachment of modular input/output (IO) boards for expansion of peripheral connectivity beyond standard IO ports. As shown in FIG. 10, modular IO boards attach to the control board through standardized connectors, enabling field-upgradeable expansion of fixture capabilities. In certain embodiments, modular IO boards include one or more of: additional power supplies, specialty connectors, antennas, communication interfaces, sensor modules, signal conditioning circuits, additional serial interfaces such as UART, SPI, or I2C, wireless communication capabilities such as Wi-Fi, Bluetooth, Zigbee, or cellular connectivity, and analog-to-digital or digital-to-analog conversion modules. The modular IO board architecture enables EOL production fixture platform 104 to be configured for diverse testing requirements without modification to bay controller 204 or replacement of the base control board.

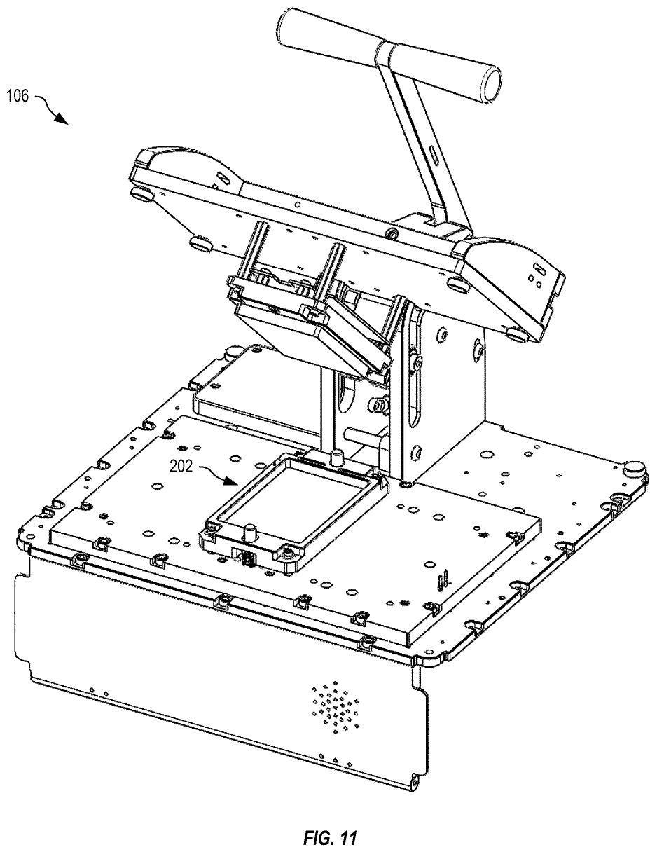

FIGS. 11-16 are assembly diagrams illustrating various DUT bay configurations for EOL production fixture platform 104, in embodiments. The fixture platform accommodates electronic devices of varying form factors through modular DUT bay configurations that mechanically and electrically interface with DUT 140 during testing. Each DUT bay configuration includes mechanical alignment features, electrical contact points, and retention mechanisms appropriate for the target device form factor.

FIG. 11 illustrates a DUT bay configuration for receiving a single small-form-factor electronic device. This configuration is suitable for testing compact IoT devices, wearables, sensors, or similar devices having a small physical footprint. The single-device configuration dedicates all measurement and actuation peripherals of the bay to one DUT 140, enabling comprehensive testing with maximum peripheral availability.

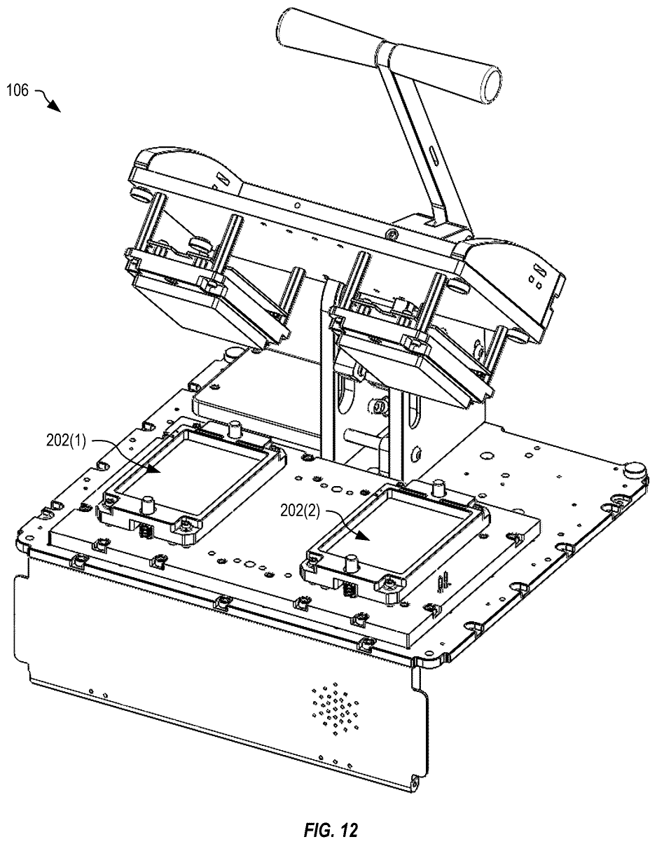

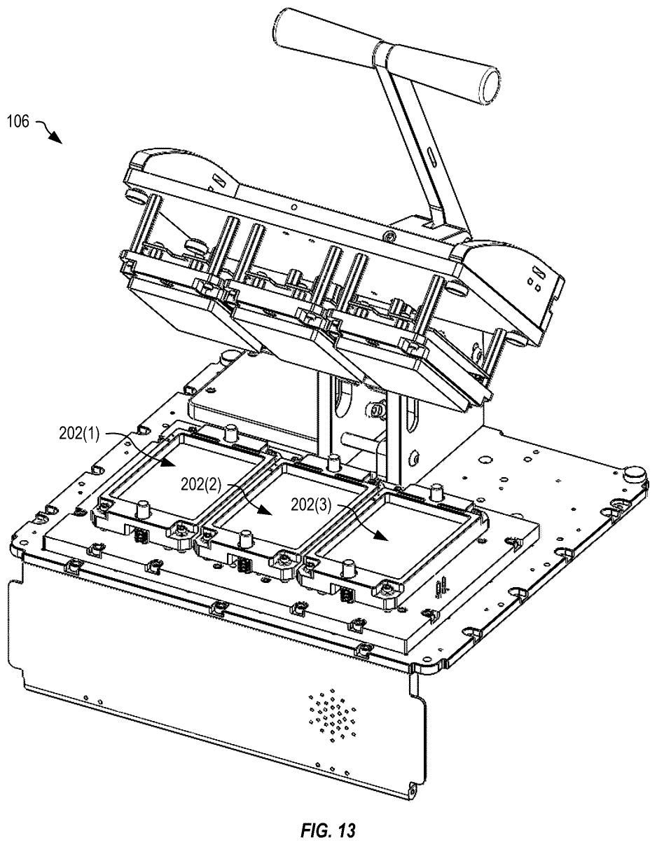

FIG. 12 illustrates a DUT bay configuration for receiving two small-form-factor electronic devices in parallel. FIG. 13 illustrates a DUT bay configuration for receiving three small-form-factor electronic devices in parallel. These multi-device configurations enable parallel testing of multiple small devices within a single DUT bay 202, increasing throughput for high-volume production of small-form-factor devices. In certain embodiments, test runner suite 108 executes independent test flows for each device position within the multi-device bay configuration while sharing common power and communication infrastructure.

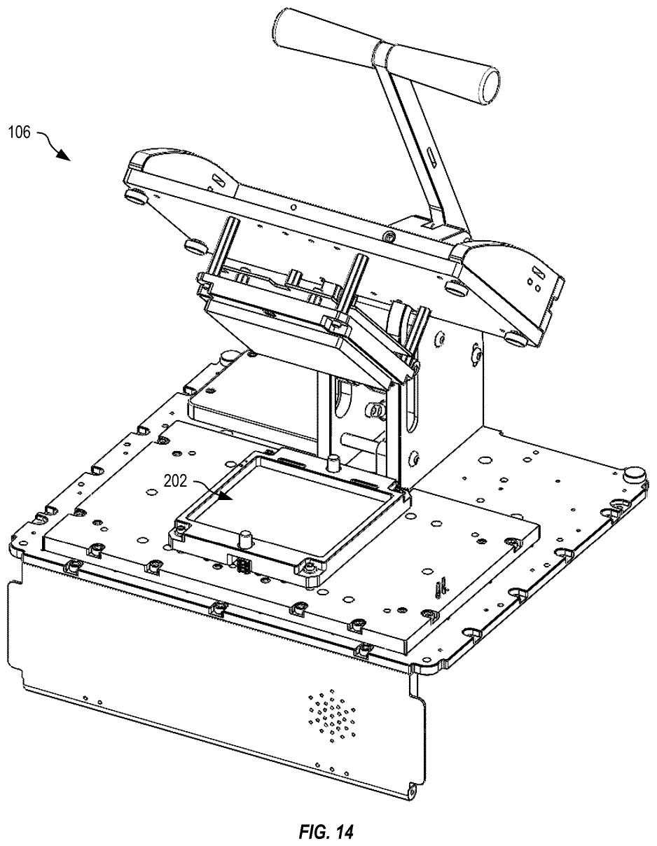

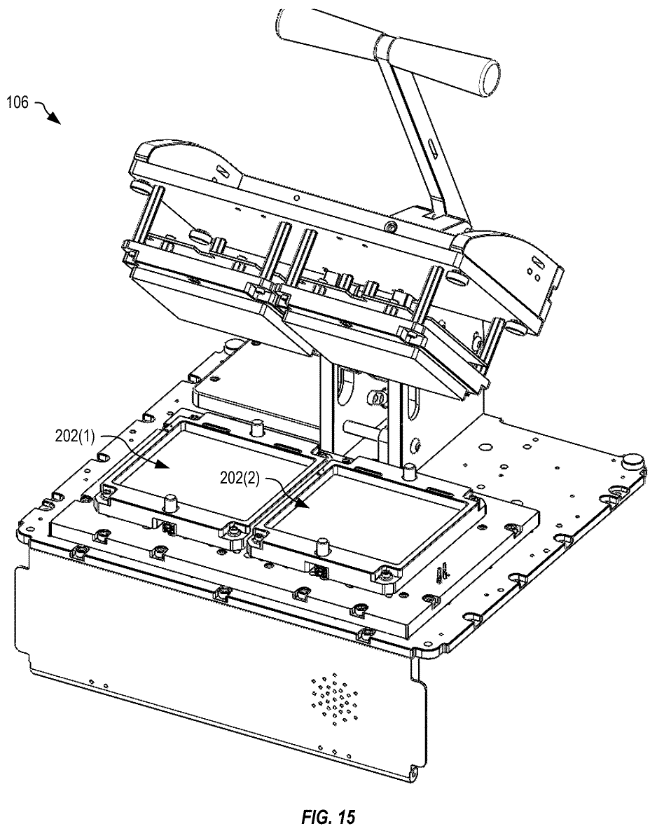

FIG. 14 illustrates a DUT bay configuration for receiving a single medium-form-factor electronic device. FIG. 15 illustrates a DUT bay configuration for receiving two medium-form-factor electronic devices in parallel. Medium-form-factor configurations accommodate devices such as smart home controllers, networking equipment, industrial sensors, or similar devices having moderate physical dimensions. The mechanical interface features are scaled appropriately for the larger device footprint while maintaining compatibility with the standard bay controller 204 interface.

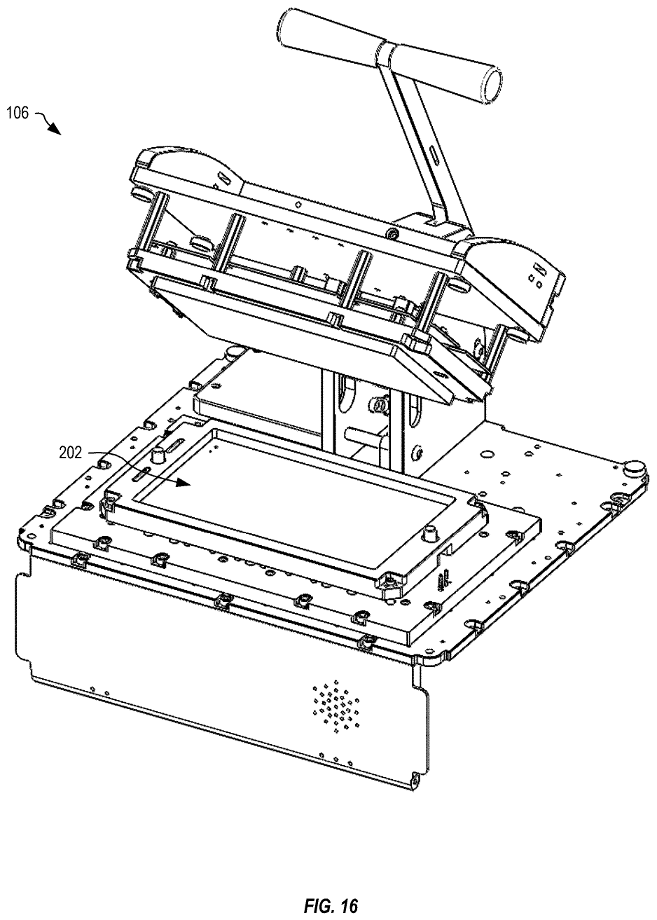

FIG. 16 illustrates a DUT bay configuration for receiving a single large-form-factor electronic device. Large-form-factor configurations accommodate devices such as industrial controllers, gateway devices, or complex assemblies requiring extended physical space. In certain embodiments, the large-form-factor configuration utilizes the full available area of DUT bay 202 and may include additional mechanical support structures for device retention during testing.

The modular DUT bay configuration architecture enables EOL production fixture platform 104 to be adapted for different product lines by exchanging the DUT bay configuration without requiring replacement of host computer 210, bay controller 204, or fixture core framework 212. In certain embodiments, a single EOL production fixture platform 104 may be reconfigured between production runs to accommodate different device form factors by exchanging the DUT bay configuration and updating the active test flow document in test runner suite 108.

### Daisy-Chain Configuration Details

FIG. 17 is an assembly diagram illustrating daisy-chain electrical interface 224 between control boards 206 of adjacent fixture platforms, in embodiments. FIG. 18 is an assembly diagram illustrating a complete daisy-chained assembly comprising multiple fixture platforms connected via daisy-chain mechanical coupling 226, monitored from a single host computer, in embodiments. Multiple EOL production fixture platforms 104 may be daisy-chained together via daisy-chain electrical interface 224 and daisy-chain mechanical coupling 226 to expand the number of DUT bays 202 available for testing while maintaining unified monitoring from a single host computer 210.

As shown in FIG. 17, the daisy-chain connection is established through daisy-chain electrical interface 224 between control boards 206 of adjacent fixture platforms, with daisy-chain mechanical coupling 226 providing physical alignment and secure mating of the electrical connectors. Daisy-chain electrical interface 224 includes power distribution, communication bus signals, and synchronization signals enabling coordinated operation across the daisy-chained assembly. Daisy-chain mechanical coupling 226 ensures proper alignment of daisy-chain electrical interface 224 connectors and provides structural support for the interconnected fixture platforms. Daisy-chain electrical interface 224 may utilize one or more of: serial communication protocols such as RS-485, CAN bus, or Ethernet; dedicated synchronization signals for test timing coordination; and shared power distribution for consistent voltage references across fixture platforms. Daisy-chain mechanical coupling 226 may include alignment features, latching mechanisms, or fasteners appropriate for the deployment environment.

As shown in FIG. 18, a complete daisy-chained assembly comprises multiple EOL production fixture platforms 104 connected in series via daisy-chain mechanical coupling 226, with a single host computer 210 providing unified monitoring and control. Fixture core framework 212 enumerates connected fixture platforms and manages test operations across all available DUT bays 202 as if they were part of a single expanded fixture platform. In certain embodiments, test configurations generated from fixture controller source code 509 and fixture procedure source code 510 for use on a single fixture platform operate on the daisy-chained assembly without modification, with fixture core framework 212 automatically distributing test operations across available DUT bays 202.

The daisy-chain architecture enables scalable expansion of testing capacity to meet production volume requirements. In certain embodiments, daisy-chained fixture platforms may be added or removed without reconfiguration of host computer 210 or modification of test procedures, enabling flexible capacity adjustment based on production demands.

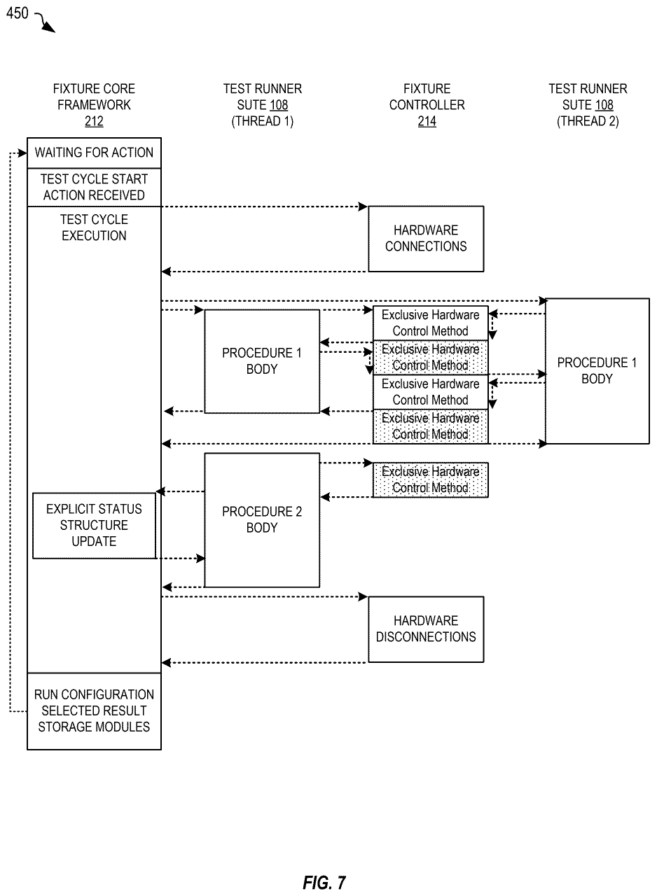

FIG. 7 is a sequence diagram illustrating a DUT test sequence 450, in embodiments. The sequence diagram shows the temporal ordering of interactions between fixture core framework 212, bay controller 204, bay controller firmware 222, and DUT 140 during execution of a test cycle. Upon initiation of a test cycle by test sequencer 505, fixture core framework 212 transmits test commands to bay controller 204 via fixture controller 214.

### A Method for Locating Test Runner Agent on Remotely Connected Systems

In certain embodiments, where EOL production fixture platform 104 is involved in testing that is running on an operating system of an external system, a portion of fixture core framework 212 called a “test runner agent” may be deployed onto the external system to allow remote control of hardware via fixture core framework 212. This remote control may be performed over any communication channel available between the two systems, for example an RS-232 or Ethernet connection.

While fixture core framework 212 typically connects “fixture controller” software to hardware that is running on EOL production fixture platform 104 itself, the “test runner agent” may also connect “fixture controller” software to hardware that is running on a different computer (e.g., a DUT). The drivers that are available for such remote control are connected to by the “test runner agent” and are at that point usable by fixture core framework 212 as if the hardware were connected to the same computer that fixture core framework 212 is running on. “Test procedures” may attempt to use the “fixture controller” software the same way regardless of whether it is running locally or being remotely controlled by the “test runner agent”.

Fixture core framework 212 achieves this machine independent operation by: (1) The “test runner” using the “fixture core” defines a remote controllable copy of an existing “fixture controller” using a function provided by “fixture core” software. (2) When “fixture core” would attempt to connect the “fixture controller” software to hardware, remote controllable copy instead attempts to connect to the “test runner agent” software at the remote network location. (3) The “fixture core” sends the original copy of the “fixture controller” software to the agent for remote execution. (4) When “fixture core” attempts to run functions of the “fixture controller” software, the functions of the remote controllable copy are instead executed.

The functions of the remote controllable copy send the function calls to the “test runner agent” for execution on its computer.

The “test runner agent” achieves this machine independent operation by: (1) Waiting for an instance of “fixture core” to connect. (2) Receiving a “fixture controller” software from the connected “fixture core”. (3) Connecting the “fixture controller” software to the hardware of the computer the “test runner agent” is running on. (4) Running the methods requested by the “fixture core” software and returning the results over the network.

### Result Reporting System for Test Runners

When a test fixture completes a test cycle, the test results are stored in a general purpose intermediary format. The “fixture core” portion of the test runner software examines its configuration for instructions on what to do with the test results after each cycle. The instructions consist of a list of code modules to send test results to. Each code module may independently dispatch the result to various storage mediums or networked destinations or displays depending on the contents of the module.

Test modules can be created and deployed on a per-user basis to achieve integration with other systems a user may also be using. An example test result module might receive the test results from the “fixture core” software and arrange them into corresponding fields in a pre-existing tracking database to achieve integration with another system.

### Auto-Selection of Active Configuration Based on Barcode

When an operator of EOL production fixture platform 104 uses a barcode scanner to identify an IoT device 140 to fixture core framework 212 (using barcode tracker 503), fixture core framework 212 invokes user-defined code to process the scanned value. This user-defined code may modify the active configuration of fixture core framework 212 in response to the scanned value, enabling automatic selection of test flows or fixture roles based on device identification.

### Fixture Gateway

Fixture gateway software 110 may be installed on one or more fixture platforms and enables remote monitoring, updating, and control of software and configuration of the fixture platform on which it is installed.

Fixture gateway software 110 may maintain a connection to fixture fleet manager 150 on a local network or the internet. Messages published to the server are received by fixture platforms connected to the server and may be used to view the status of and/or perform reconfigurations of instances of test runner suite 108 in the context of device manufacturing, such as modifying tolerance values or changing the ordering of tests performed during manufacture. Fixture gateway software 110 may also report test results to fixture fleet manager 150 for central aggregation.

A web application (local management dashboard 153) may be hosted on a fixture platform, separate from fleet manager dashboard 151 and GUI application 332, to visualize status information and to send commands to fixture platforms connected to fixture fleet manager 150 when an operator deploys a change to a connected fixture platform.

### Fleet Manager

In certain embodiments, IoT lifecycle management system 100 may include a fixture fleet manager 150 that is a centrally hosted application that communicates with fixture gateway software 110 running on multiple fixtures. Fixture fleet manager 150 may be hosted on a local network or connected via the internet, providing flexibility in deployment architecture. In embodiments, fixture fleet manager 150 includes a user-facing element (“Fleet manager dashboard” 151) and an element that runs continually regardless of user interaction (e.g., fleet manager backend 152).

Fleet manager dashboard 151 may display the status of all fixtures (e.g., EOL production fixture platforms 104) of IoT lifecycle management system 100 and issue reconfiguration commands, test flow changes, and software version changes to selected fixtures or fixture groups. In certain embodiments, fleet manager dashboard 151 displays test result history across the fixture fleet, enabling trend analysis and identification of systematic issues affecting multiple production lines. The dashboard may present log output of fixture core framework 212 for diagnostic and troubleshooting purposes.

In embodiments, fixture fleet manager 150 provides statistical analysis of system usage, including metrics such as pass/fail rates, average cycle duration, total number of cycles completed, and fixture utilization rates. These statistics may be aggregated across individual fixtures, production lines, or manufacturing facilities, enabling performance comparison and identification of optimization opportunities. Fleet manager backend 152 may continuously collect and process operational data from connected fixtures, maintaining historical records and generating alerts when predetermined thresholds are exceeded or anomalous patterns are detected.

Fixture fleet manager 150 controls connected devices by maintaining a network connection to each device. This connection is also used to monitor and store the status of connected devices. The connection is used to issue updates to test runner suite 108.

### Local Management Dashboard

Host computer 210 in EOL production fixture platform 104 may host a web-based control panel (Local management dashboard 153) that can reconfigure and update test runner suite 108 without involvement of a central broker. In embodiments, EOL production fixture platform 104 maintains a separate local configuration that local management dashboard 153 can act upon and switch to without overwriting a fleet manager specified remote configuration. This dual-configuration architecture may provide operational flexibility, allowing EOL production fixture platform 104 to function independently when network connectivity is unavailable or when local control is preferred.

Local management dashboard 153 may connect to fixture gateway software 110 running on the same device to carry out operations. In certain embodiments, local management dashboard 153 controls configuration and software versions running on the same device. Local management dashboard 153 may display test results, test run statistics, and operational metrics. In embodiments, local management dashboard 153 provides real-time monitoring of test cycle progress, historical test result analysis, and diagnostic information for troubleshooting EOL production fixture platform 104. The web-based interface may be accessible through standard network protocols, enabling management from connected devices without requiring specialized client software.

### Unified Test Fixture Architecture for Mixed Connectivity Use Cases (Locally, Local Network, Cloud)

The present embodiments provide a method for performing networked configuration and control of test fixtures through a unified architecture that supports mixed connectivity use cases, including standalone devices, local networks, and cloud-based platforms. IoT lifecycle management system 100 may include several key components: EOL production fixture platform 104, test runner suite 108, fixture gateway software 110, and fixture fleet manager 150.

The test fixture is the primary hardware component, housing the DUT (e.g., IoT device 140 of FIG. 1) and providing the necessary interfaces for communication and control. The fixture software, executing on the test fixture, manages the fixture's functionality, including test execution and status reporting. The fixture software consists of two main components: the test runner and the GUI.

The test runner is responsible for coordinating the execution of test sequences and collecting test results. It operates according to a given or stored configuration, connecting to hardware as defined by the author of the test sequences.

The GUI provides a user interface for configuring, monitoring, and controlling the test fixtures remotely. The modular design of the GUI allows it to run on a separate device from the fixture, enhancing system flexibility and ease of use for operators and engineers.

The message broker functions as the central communication hub within the system, facilitating the exchange of messages between instances of fixture gateway software 110 and other subscribed entities. The message broker can be deployed in various configurations, depending on the specific requirements and constraints of the deployment environment. It can be hosted on a cloud platform, offering scalability, reliability, and accessibility from any location with an internet connection. Alternatively, the message broker can be hosted locally within the organization's network infrastructure, providing greater control over data security and privacy.

The fixture gateway software 110 manages the communication between the test fixtures and the message broker. It acts as an intermediary, handling the establishment and maintenance of the connection to the message broker, as well as the transmission and receipt of messages. The fixture gateway software 110 can be implemented in two ways: as a web-hosted service or directly on the test fixture.

When implemented as a web-hosted service, the fleet manager dashboard of fixture fleet manager 150 allows for access and management of other connected devices through a web interface. Alternatively, the fleet manager dashboard can be implemented directly on the test fixture and used without internet connectivity, providing access control and management of test runner software running on the same device. This approach may be preferable in situations where internet connectivity is limited or where a higher degree of autonomy is required.

The unified architecture of IoT lifecycle management system 100 may leverage bidirectional communication protocols suitable for IoT applications, such as MQTT. These protocols may establish and maintain a connection initiated from a local network to the internet, allowing a connected entity to send messages back through routers and firewalls without necessitating complex IT configurations. This may enable continuous connectivity without the need for elaborate network setup. The architecture may support various network topologies, including client-server, peer-to-peer, and mesh networks, providing greater flexibility compared to protocols such as Representational State Transfer (REST) interfaces.

The modular architecture of EOL production fixture platform 104, test runner suite 108, and fixture gateway software 110 may enable adaptation to various deployment scenarios and connectivity configurations. In embodiments, the separation of test execution logic from hardware interface drivers allows test runner suite 108 to operate across different fixture hardware configurations without modification to core test procedures. Fixture gateway software 110 may support multiple communication protocols and network topologies, enabling integration with existing manufacturing execution systems, enterprise resource planning systems, and IoT device management platforms.

In certain embodiments, the modular design allows replacement or addition of hardware interface modules without requiring changes to test runner suite 108 or fixture gateway software 110. This architecture may accommodate deployment environments with varying network connectivity, ranging from air-gapped local networks to cloud-connected manufacturing facilities. The system may operate in standalone mode, local network mode, or internet-connected mode, with configuration parameters determining which features and communication pathways are active in a given deployment.

### Containerized Test Runner Software Structure and Updates

Test runner suite 108 may be built into a container for use during production. In embodiments, an active software version can be updated by fetching containerized software from a network location and running contents of the container. The container corresponding to a desired version may be selected on a per-fixture basis by a user working locally at the computer via local management dashboard 153, or on a group basis via a network using fixture fleet manager 150.

In certain embodiments, fixture fleet manager 150 coordinates containerized software deployment across multiple EOL production fixture platforms 104 simultaneously, enabling synchronized updates to ensure consistent test procedures across a production line or multiple production facilities. Fixture fleet manager 150 may maintain version control, allowing rollback to previous container versions if issues are detected after deployment. The containerized architecture may provide isolation between different software versions, enabling testing of new configurations on selected EOL production fixture platforms 104 while maintaining stable versions on others. In embodiments, fixture gateway software 110 manages the download, verification, and activation of updated containers, ensuring secure and reliable software updates without requiring manual intervention at each fixture platform 104.

### Root of Trust Provisioning System

EOL production fixture platform 104 establishes device trust based on hardware characteristics intrinsic to DUT 140. Such hardware characteristics may include physically unclonable function (PUF) measurements, trusted platform module (TPM) attestations, secure element key material, or other hardware-based identity mechanisms. This approach may reduce or eliminate reliance on externally provisioned credentials or software-based licensing mechanisms. In certain embodiments, a human operator is involved in onboarding an original equipment manufacturer (OEM) and contract manufacturer (CM) to EOL production fixture platform 104. The system architecture enables automated verification that DUT 140 originated from an authorized manufacturing process through root-of-trust validation. The hardware root-of-trust may be established through various mechanisms including PUF measurements, secure element key attestation, trusted platform module (TPM) endorsement, or other hardware-based cryptographic foundations. PUF-based implementations provide additional tamper-evidence properties as described herein.

The present embodiments provide a modular architecture in which components may be combined to fulfill varying device requirements. Modules include provisioning and identity generation suite 112 for establishing device trust, device management service 142 for lifecycle operations, and secure communication network 130 for smart contract and cloud-based service integration. By establishing trust intrinsic to DUT 140 through hardware characteristics such as PUF measurements, DUT 140 may be authenticated to interact with IoT systems, smart contracts 710, and cloud-based services. This trust architecture further enables capabilities including fractional device ownership and blockchain wallet management through blockchain 708.

Conventional manufacturing processes require trust in the contract manufacturer (CM) to properly handle device secrets and credentials. The present embodiments reduce or eliminate dependence on CM trust by deriving device identity from characteristics intrinsic to DUT 140 rather than from secrets stored on or transmitted through the manufacturing infrastructure. EOL production fixture platform 104 does not store device secrets that could be compromised; instead, device identity is established through root-of-trust validation performed by provisioning and identity generation suite 112. In certain embodiments, the root-of-trust is derived from physically unclonable function (PUF) measurements. In embodiments involving blockchain wallet creation, EOL production fixture platform 104 initiates API requests to Authority 706 for each wallet, wherein wallet credentials are derived from the root-of-trust of DUT 140 rather than from secrets maintained by the CM or EOL production fixture platform 104.

EOL production fixture platform 104 implements hardware security mechanisms to establish trust in the fixture platform itself. In certain embodiments, a control board of EOL production fixture platform 104 includes a secure element for storing cryptographic secrets. The secure element may comprise one or more of a dedicated cryptographic chip, a hardware security module (HSM), a physically unclonable function (PUF) circuit, or a trusted platform module (TPM). In embodiments utilizing a PUF circuit, the PUF may additionally provide intrusion detection, wherein tampering with EOL production fixture platform 104 alters PUF measurements and invalidates derived credentials. The fixture PUF root-of-trust 704 is distinct from the device PUF root-of-trust 724 provisioned on DUT 140; fixture PUF root-of-trust 704 authenticates EOL production fixture platform 104 itself, while device PUF root-of-trust 724 establishes the hardware-based identity of DUT 140 for lifecycle management. The secure element implementation may be selected based on security requirements, cost constraints, and deployment environment considerations.

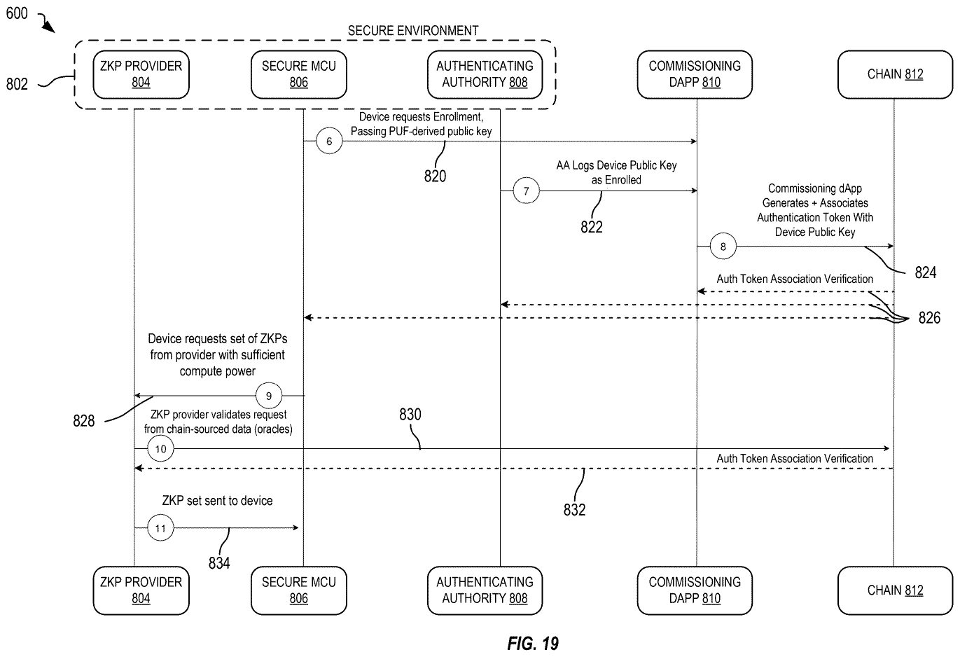

PUF provisioning may be implemented through use of device SDK 160 of FIG. 1. FIG. 19 illustrates an example provisioning sequence 600 which may be implemented through device SDK 160, showing data flows for interaction between IoT devices and smart contract platforms during device onboarding. FIG. 20 illustrates provisioning of DUT 140 with device PUF root-of-trust 724, showing the relationship between EOL production fixture platform 104, Authority 706, and blockchain 708 during device registration. FIG. 21 illustrates the dual MCU architecture of DUT 140, showing how application MCU 700 and secure MCU 702 coordinate to implement PUF-based authentication and blockchain wallet functionality. Device SDK 160 provides low-level infrastructure for onboarding devices through use of a root-of-trust to generate and manage cryptographic keys, where trust is enhanced by PUF measurements and zero-knowledge proofs (ZKPs).

Strong PUF provisioning creates a unique key for smart contract platforms alongside a dataset that enables the generation of challenge queries for PUF verification, without revealing answerable information within the dataset itself. Weak PUF provisioning generates one or more keys through PUF media analysis, suitable for direct use without the feasibility of challenge-response authentication due to the inherent characteristics of weak PUFs. Multi-factor PUF provisioning uses multiple PUFs in coordination to fulfill complex authentication protocols, requiring simultaneous verification across various conditions or devices for enhanced security.

EOL production fixture platform 104 may implement PUF bonding, wherein PUF structures are introduced as integral components of tamper-sensitive structures of DUT 140. Tamper-sensitive structures are physical elements configured such that unauthorized physical access or tampering irreversibly alters their measurable characteristics, thereby invalidating any hardware root-of-trust derived from those characteristics. These PUF structures may reside within secure environments of DUT 140 or may serve as a secure interface at environmental boundaries of the device. PUF bonding enables provisioning and identity generation suite 112 to implement one or more of the following applications: Sensor-based key generation: PUF measurement circuits interface with physical structures of DUT 140 or attached objects to derive cryptographic keys from measurable physical characteristics unique to those structures. In certain embodiments, device management service 142 supports graceful degradation of authentication capability based on PUF validity, wherein device management service 142 permits full authentication capability when valid PUF measurements are obtainable, and permits restricted communication with lifecycle management platform 120 when valid PUF measurements are not obtainable due to sensor readings outside a predetermined range. Passive asset security: PUF circuits operating without active power provide challenge-response authentication for securing digital assets, wherein the PUF properties persist independently of device operational state. Environmental integrity validation: PUF structures configured to produce altered measurements under abnormal environmental conditions, such as temperature extremes, humidity, or mechanical stress, thereby enabling detection of environmental excursions that may compromise device integrity. Multi-parameter validation: Multiple PUF structures with distinct environmental sensitivities combined to validate specific operational parameters, wherein each PUF structure responds to a different physical condition. End-of-life incentivization: PUF structures configured such that proper disassembly of DUT 140 during recycling or disposal reveals cryptographic keys enabling access to incentive mechanisms, while improper disassembly destroys the PUF structure and forfeits access to such incentives.

PUF measurement circuits may measure unique physical characteristics of device structures using various sensing modalities including, but not limited to: optical imaging for capturing unique visual patterns such as surface textures, wood grain, natural material variations, or manufactured patterns; optical imperfection analysis for characterizing unique defects, scratches, or irregularities in optical components, lenses, or transparent substrates; capacitive sensing for detecting unique dielectric properties, structural variations, or moisture-sensitive characteristics; time-domain reflectometry (TDR) for characterizing unique impedance profiles of electrical pathways, physical interconnects, or transmission line discontinuities; acoustic resonance measurement for detecting unique vibrational signatures, resonant frequencies, or acoustic damping properties of mechanical structures; radio-frequency spectral analysis for characterizing unique electromagnetic emission patterns, antenna response variations, or RF component tolerances; thermal response profiling for measuring unique heat dissipation patterns, thermal conductivity variations, or temperature-dependent resistance characteristics; piezoelectric response characterization for measuring unique voltage responses of piezoelectric materials under mechanical stress or vibration; surface texture analysis for characterizing microscopic surface features, roughness profiles, or topographical variations; and MEMS structural resonance for measuring unique mechanical resonance frequencies of microelectromechanical system components such as accelerometers or gyroscopes. The selection of sensing modality may depend on the physical structures being measured, the operational environment of the electronic device, and the required authentication security level. Multiple sensing modalities may be combined to implement multi-factor PUF authentication requiring simultaneous verification across distinct physical characteristics.

EOL production fixture platform 104 may configure a device with a PUF structure that improves end-of-life management by providing incentivization for proper handling of the device when at the end of its life. For example, EOL production fixture platform 104 configures a PUF structure (e.g., device PUF root-of-trust 724 of FIG. 20) on a device (e.g., IoT device 140) to define trust and value for the device. This trust and value may incentivize proper end-of-life refurbishment (e.g., by recycler 180). Disassembly, recycling, and disposal of the device and/or its constituent materials may also be financially incentivized. For example, the end-of-life management process for the device may access secrets stored in the device in return for a tokenized reward distributed automatically through smart contract integration upon verified proper end-of-life processing.

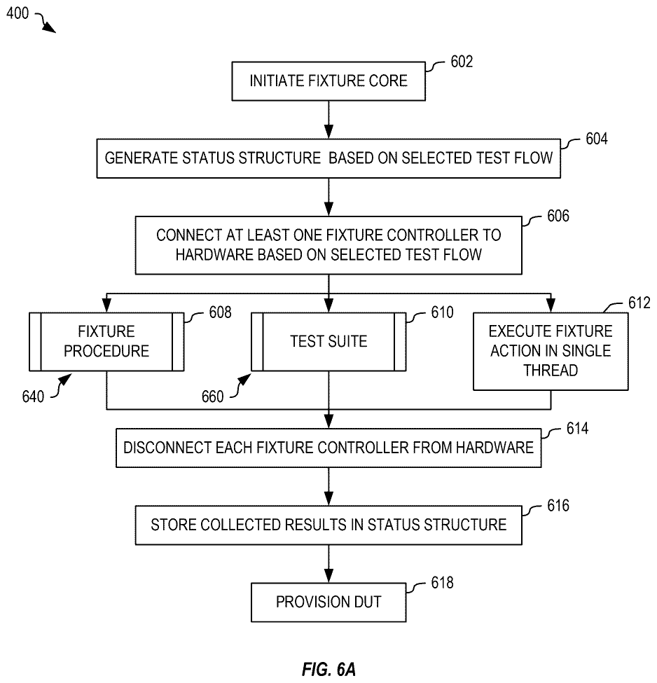

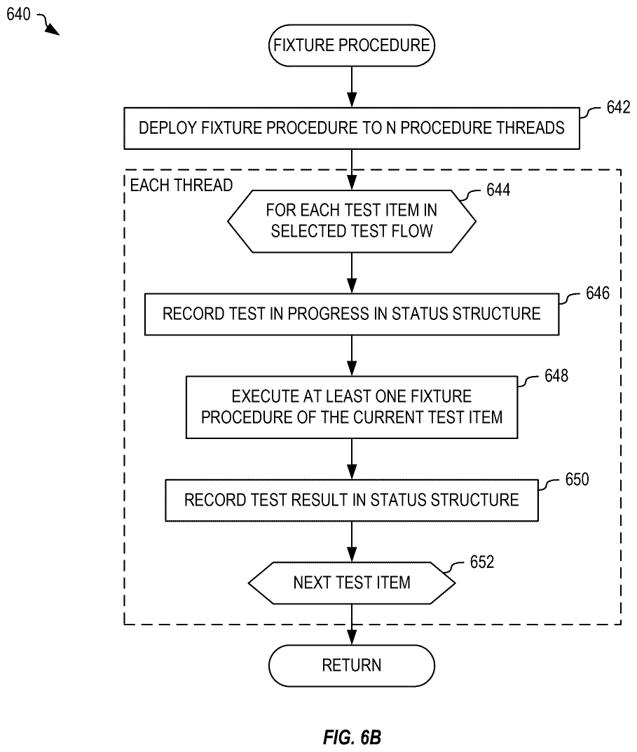

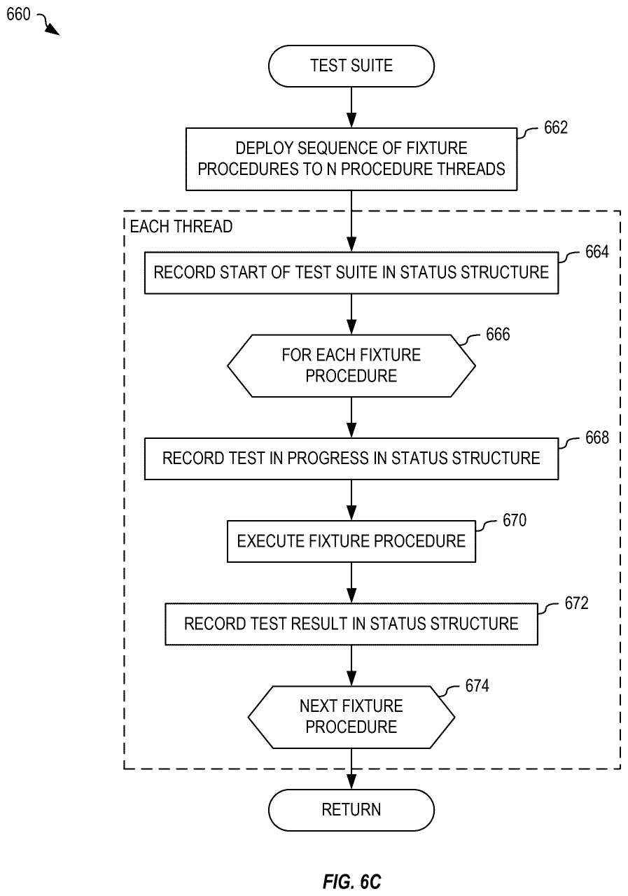

FIGS. 6A, 6B, and 6C are flowcharts illustrating one example method 400 for test cycle execution of EOL production fixture platform 104 of FIG. 1, in embodiments. Method 400 is implemented at least in part by host computer 210 of EOL production fixture platform 104 (e.g., see FIG. 2). Method 400 includes establishing communication with DUT 140 via IoT device physical interface fixture 106, initiating DUT test sequence 450 through test sequencer 505, executing test operations defined in fixture procedure 216 via fixture controller 214, evaluating measurement results against pass/fail criteria, and storing results via result storage module 514.

In block 602, method 400 initiates the fixture core. In one example of block 602, fixture core framework 212 is initiated on host computer 210 and connects to at least one GUI client 506. Fixture core framework 212 may receive (e.g., from a local user or a remote user) a selection of a test flow defined by test flow documents 306. In block 604, method 400 generates a status structure based on a selected test flow. In one example of block 604, result storage module 514 generates status structure 404 in preparation for storing status and test result data for a selected test procedure. In block 606, method 400 connects at least one fixture controller to hardware based on the selected test flow. In one example of block 606, fixture controller 214 connects to hardware of fixture platform 104 based on one or more test flow documents 306. For example, fixture controller 214 dynamically binds to appropriate hardware drivers for one DUT bay 202 and associated peripherals.

Based on the selected test flow, method 400 proceeds with one of blocks 608, 610, and 612. In block 608, method 400 invokes a fixture procedure subroutine 640, which returns to continue with block 614. In block 610, method 400 invokes a test suite subroutine 660, which returns to continue with block 614. Blocks 608 and 610 are shown as subroutines for clarity of illustration; however, block 608 and 610 may also be implemented inline without departing from the scope hereof.

In block 612, method 400 executes a fixture action in a single thread. In one example of block 612, fixture core framework 212 executes a fixture action using a single thread.

In block 614, method 400 disconnects each fixture controller from hardware. In one example of block 614, fixture core framework 212 disconnects each fixture controller 214 from hardware of fixture platform 104. In block 616, method 400 stores collected test results in the status structure. In one example of block 616, fixture core framework 212 invokes result storage module 514 to store collected results in status structure 404 of result data 402. In block 618, method 400 provisions the DUT. In one example of block 618, fixture core framework 212 invokes provisioning and identity generation suite 112 to provision DUT 140 when status structure 404 indicates DUT 140 has passed the tests.

In block 642, subroutine 640 deploys the fixture procedure to N procedure threads. In one example of block 642, fixture core framework 212 deploys fixture controllers 214 to N different threads of host computer 210, where N is the number of DUTs being tested on fixture platform 104. Each deployed fixture controller 214 is substantially identical such that each DUT 140 positioned in one of DUT bays 202 is tested according to test flow documents 306.

Blocks 644 through 652 are implemented for each thread. Block 644 is a start of a loop that iterates through each test item in the selected test flow. In block 646, subroutine 640 records test in progress in the status structure. In one example of block 646, fixture core framework 212 updates status structure 404 to indicate that the current test item is in progress. In block 648, subroutine 640 executes at least one fixture procedure of the current test item. In one example of block 648, test runner suite 108 executes at least one fixture procedure 216 to perform the current test item on one DUT bay 202. In block 650, subroutine 640 records test results of the current test item in the status structure. In one example of block 650, fixture core framework 212 invokes result storage module 514 to update at least a portion of status structure 404 with test results of at least one fixture procedure 216. Block 652 is the end of the loop and returns to block 646 with a next test item in the test flow. When each thread has completed all test items, subroutine 640 returns to block 614 of method 400.

In block 662, subroutine 660 deploys a sequence of fixture procedures to N procedure threads. In one example of block 662, fixture core framework 212 deploys a sequence of fixture procedures 216 to N different threads of host computer 210, where N is the number of DUTs being tested on fixture platform 104. Each deployed fixture procedure 216 is substantially identical such that each DUT 140 positioned in one of DUT bays 202 is tested according to test flow documents 306.

Blocks 664 through 672 are implemented for each thread. Block 664 is a start of a loop that iterates through each fixture procedure of the fixture procedure sequence. In block 666, subroutine 660 records test in progress in the status structure. In one example of block 666, fixture core framework 212 updates status structure 404 to indicate that the current fixture procedure is in progress. In block 668, subroutine 660 executes the current fixture procedure of the current test item. In one example of block 668, test runner suite 108 executes fixture procedure 216 to test DUT 140 at one DUT bay 202. In block 670, subroutine 660 records test results of the current test item in the status structure. In one example of block 670, fixture core framework 212 invokes result storage module 514 to update at least a portion of status structure 404 with test results of fixture procedure 216. Block 672 is the end of the loop 674 and returns to block 666 with a next fixture procedure in the sequence. When each thread has completed the fixture procedure sequence, subroutine 660 returns to block 614 of method 400.

FIG. 19 is a data flow diagram illustrating one example sequence 600 for provisioning IoT device 140 of FIG. 1, in embodiments. Sequence 600 is implemented through use of device SDK 160 of FIG. 1, for example, and illustrates an example provisioning model for interaction between IoT devices and smart contract platforms. Device SDK 160 may support open decentralized platforms and/or proprietary private platforms. Smart contracts may verify authenticity of IoT device 140, and IoT device 140 may self-manage cryptographic transactions, thereby enabling participation in decentralized marketplaces and device management platforms.

A secure environment 802 includes a ZKP provider 804, a secure MCU 806, and an authenticating authority 808. Secure MCU 806 sends a device request enrollment message 820 to a commissioning dApp 810 and authenticating authority 808 sends a public key 822 to commissioning dApp 810. Commissioning dApp 810 sends an authentication token 824 to a chain 812 which responds by sending an authentication token verification 826 to each of secure MCU 806, authenticating authority 808, and commissioning dApp 810. Secure MCU 806 then sends a ZKP request 828 to ZKP provider 804, which validates the request and sends a message 830 to chain 812. Chain 812 authenticates message 830 and sends an authentication token association verification 832 to ZKP provider 804, which sends a ZKP set 834 to secure MCU 806.

### Decentralized IoT Platform Management

In certain embodiments, integrating decentralized and trustless system properties into physical products requires domain-specific development to address constraints of low-cost, low-power embedded computing devices such as DUT 140. The present embodiments provide infrastructure, including secure communication network 130 and provisioning and identity generation suite 112, for smart contracts 710 to securely provision and interact with DUT 140. This architecture extends blockchain 708 trustless, decentralized, and composable functionality into IoT devices and enables public auditability of device authenticity through device management service 142.

Device security throughout the lifecycle from manufacturing to decommissioning involves considerations including supply chain integrity and threat mitigation. The present embodiments address device security through integration of physically unclonable functions (PUFs) and zero-knowledge proofs (ZKPs) into EOL production fixture platform 104 via provisioning and identity generation suite 112. This architecture supports supply chain risk management (SCRM) by enabling cryptographic verification of device provenance at each lifecycle stage. In certain embodiments, ZKP integration enables operating modalities that enhance user privacy while maintaining platform auditability through secure communication network 130.

A PUF is a measurable structure with random properties that cannot be controlled, which can provide a ‘digital fingerprint’ intrinsically tied to a physical object. The ability to connect device identity, ownership, and functions to PUF key signatures allows novel and important use cases such as providing strong physically-grounded proof of a digital sensor event, or financially incentivizing proper end-of-life management.

FIG. 20 is a schematic diagram illustrating example provisioning of IoT device 140 of FIG. 1 with a device PUF root-of-trust 724, in embodiments. Device PUF root-of-trust 724 is established on DUT 140 during manufacturing and is distinct from fixture PUF root-of-trust 704, which authenticates EOL production fixture platform 104. During the manufacturing phase shown in FIG. 1, EOL production fixture platform 104 provisions IoT device 140 with device PUF root-of-trust 724 and registers IoT device 140 with an Authority 706 (e.g., creating an account and registering the device identity on a blockchain 708) such that IoT device 140 may be authenticated and tracked through its operational phase to its recycling phase by a lifecycle management platform 120 (see FIG. 1). As shown in FIG. 20, in certain embodiments the provisioning process includes four steps. In step (1) Deploy, provisioning and identity generation suite 112 deploys device management service 142 to DUT 140 through a communication interface established via IoT device physical interface fixture 106. In step (2) Measure & Bond, provisioning and identity generation suite 112 measures PUF characteristics from device PUF root-of-trust 724 and integrates PUF measurement circuits with tamper-sensitive structures of DUT 140 such that tampering with the structures irreversibly alters PUF measurements. In step (3) Register Device ID, EOL production fixture platform 104 registers the device identity derived from device PUF root-of-trust 724 with Authority 706, which records the registration on blockchain 708 via smart contracts 710. In step (4) Authenticate, DUT 140 authenticates to smart contracts 710 on blockchain 708 using the hardware root-of-trust established in step (2), enabling lifecycle management operations. Lifecycle management platform 120 may represent a third party service for managing the lifecycle of IoT device 140. For example, during its operational phase, IoT device 140 may interact with one or more smart contracts 710 that may authenticate IoT device 140 as described in more detail below. At its end-of-life, recycler 180 may authenticate IoT device 140, based on device PUF root-of-trust 724 and via Authority 706, to ensure correct recycling of IoT device 140 is performed.

A ZKP is a cryptographic method where one party can prove to another that something is true, without revealing any information beyond that statement. ZKP interfaces may be applied to device security in multiple contexts. First, during provisioning, provisioning and identity generation suite 112 may generate ZKP parameters enabling DUT 140 to prove integrity of tamper-sensitive structures without revealing the hardware root-of-trust or derived device identity. Second, secure communication network 130 may include a device authentication module configured to verify device identity using zero-knowledge proofs, enabling network-side authentication without requiring disclosure of sensitive device credentials. Third, device management service 142 may be configured to generate zero-knowledge proofs for privacy-preserving authentication, enabling DUT 140 to prove device state or operational parameters to backend services without revealing underlying device identity or sensitive data. These ZKP applications offer methods for maintaining operational privacy without compromising security or architectures designed for auditability.

IoT lifecycle management system 100 incorporates provisioning techniques implemented by provisioning and identity generation suite 112. In certain embodiments, provisioning techniques include one or more of: authentication based on challenge-response mechanisms; cryptographic key generation from hardware characteristics; multi-factor signing architectures combining multiple secure elements; and bonding methodologies that integrate tamper-sensitive structures with DUT 140 or attached objects. In certain embodiments, provisioning techniques utilize physically unclonable functions (PUFs), zero-knowledge proofs (ZKPs), hardware security modules (HSMs), trusted platform modules (TPMs), secure enclaves, or other cryptographic mechanisms. EOL production fixture platform 104 automates security provisioning, identity enrollment, functional test validation, and platform onboarding, enabling DUT 140 to undergo a secure preparation process during manufacturing. In certain embodiments, ownership transfers are verifiably recorded via secure communication network 130. In certain embodiments, responsible end-of-life recycling is incentivized through cryptographic validation of device identity, wherein proper device disassembly reveals credentials enabling access to incentive mechanisms.

IoT lifecycle management system 100 enables verification of device provenance through root-of-trust validation via provisioning and identity generation suite 112. In certain embodiments, root-of-trust validation utilizes physically unclonable functions (PUFs), cryptographic key attestation, secure element verification, or other hardware-based authentication mechanisms. The system architecture supports integration with analytical tools, such as data analytics platforms, machine learning systems, or enterprise resource planning (ERP) software, for processing device attestation data and lifecycle records maintained by secure communication network 130. Cryptographic verification of device authenticity may be performed at each lifecycle stage, from manufacturing by EOL production fixture platform 104 through operational deployment to end-of-life decommissioning.

In certain embodiments, the system architecture supports interaction between a smart contract on blockchain 708 and DUT 140. DUT 140 may perform input/output operations locally while accepting commands from or transmitting data to a backend service, which may be provided by a smart contract. The smart contract architecture may enable functional composability, wherein multiple smart contracts interact with DUT 140 or with each other to provide combined functionality.

Secure communication between DUT 140 and backend services, including smart contracts 710, involves provisioning DUT 140 with a unique identifier and authorization credentials. In certain embodiments, EOL production fixture platform 104 provisions DUT 140 with credentials derived from hardware characteristics intrinsic to DUT 140, such as PUF measurements, rather than credentials generated and stored on external servers. This approach enables provisioning and identity generation suite 112 to establish device identity without requiring persistent storage of secret keys on EOL production fixture platform 104 or external infrastructure.

In certain embodiments involving blockchain integration, DUT 140 manages a blockchain wallet with a private key derived from a hardware root-of-trust. As illustrated in FIG. 21, wallet functionality 714 on secure MCU 702 manages blockchain wallet credentials, while network interface 720 on application MCU 700 communicates with smart contracts 710 on blockchain 708. Device enrollment with a smart contract may involve a provisioning process performed by EOL production fixture platform 104 in a secured manufacturing environment. Device management service 142 executing on application MCU 700 coordinates authentication and transaction operations by invoking cryptographic functions on secure MCU 702 via inter-processor communication 712. Verification of device authenticity may be based on whether the blockchain account associated with DUT 140 possesses an authorization token, wherein the private key for the account is derived from the root-of-trust of DUT 140. Device provisioning enables access control to remote services, restricting access to authenticated devices, and enables backend services to transmit configuration changes and updates to DUT 140 based on device identity.

In certain embodiments requiring secure processing capabilities, DUT 140 includes an application MCU 700 and a secure MCU 702, organized into distinct security domains as shown in FIG. 21. Secure MCU 702 resides within a Secure Domain that isolates cryptographic operations from application-level processing. Application MCU 700 resides within an Application Domain that handles general device functionality and external communication. The Secure Domain and Application Domain communicate via inter-processor communication 712. Secure MCU 702 may handle secure operations including cryptographic transactions, wallet functionality 714, and root-of-trust management. Secure MCU 702 may include hardware acceleration for cryptographic operations such as signature generation, key derivation, or zero-knowledge proof computation via secure cryptographic processor 716. Secure MCU 702 may be implemented as a field-programmable gate array (FPGA), a microcontroller, a dedicated application-specific integrated circuit (ASIC), or a secure element of a larger system-on-chip (SoC). Secure MCU 702 may monitor telemetry relevant to backend services, such as power consumption, environmental conditions, or operational state, and may communicate with backend services including smart contracts to transmit telemetry data or execute transactions.

In certain embodiments, application MCU 700 resides within the Application Domain and performs general-purpose peripheral functions of DUT 140, providing a network interface 720 for communication with external infrastructure. As shown in FIG. 21, network interface 720 connects to an Infrastructure zone comprising blockchain 708, secure communication network 130, and Cloud 190. Network interface 720 may establish connections to blockchain 708 for smart contract 710 interactions, to secure communication network 130 for lifecycle management operations, and to Cloud 190 for firmware updates and fleet management services. Application MCU 700 may range from a minimal implementation serving primarily as a network interface, to a full-featured implementation including multimedia user interfaces, sensors, and output peripherals. Application MCU 700 may include a user interface controller 718 and may perform device management functions such as power management, battery charging, user interface control, and sensor data acquisition.

In certain embodiments, the dual-element architecture enables independent selection of secure MCU 702 and application MCU 700, allowing adaptation to varying performance, security, and cost requirements. A real-time operating system (RTOS) may execute on one or both microcontrollers, facilitating firmware portability between microcontrollers from different vendors. The RTOS may provide a hardware abstraction layer that exposes hardware peripherals through a common API regardless of underlying hardware implementation, enabling firmware developed for one microcontroller architecture to execute on a different microcontroller architecture without modification to application-level code. The RTOS may further implement network protocol stacks and support multi-threaded applications with scheduling infrastructure optimized for low-power, single-core devices. The RTOS may provide secure communication interfaces between secure MCU 702 and application MCU 700 through inter-processor communication 712.

FIG. 21 illustrates the dual MCU architecture and PUF sensor interface of DUT 140 organized into three zones: a Secure Domain, an Application Domain, and an Infrastructure zone, in certain embodiments. The Secure Domain contains secure MCU 702 and provides isolation for cryptographic operations and root-of-trust management. The Application Domain contains application MCU 700 and provides general device functionality and external communication capabilities. The Infrastructure zone, external to DUT 140, contains blockchain 708 with smart contracts 710, secure communication network 130, and Cloud 190, representing the backend services with which DUT 140 communicates for lifecycle management. Application MCU 700 within the Application Domain includes network interface 720, which may connect to any of the three example networks within the Infrastructure zone: blockchain 708 for smart contract interactions and decentralized authentication, secure communication network 130 for lifecycle management operations and firmware updates, and Cloud 190 for fleet management and analytics services. Application MCU 700 further includes user interface controller 718 for managing device user interfaces, device management service 142 for lifecycle management operations, and inter-processor communication 712(2) for communication with secure MCU 702. Secure MCU 702 within the Secure Domain includes PUF sensor interface 722 connected to device PUF root-of-trust 724, secure cryptographic processor 716 for performing cryptographic operations, wallet functionality 714 for managing blockchain wallet credentials derived from the hardware root-of-trust, and inter-processor communication 712(1) for communication with application MCU 700. Inter-processor communication 712 enables secure data exchange between the Application Domain and Secure Domain, allowing device management service 142 to invoke cryptographic operations on secure MCU 702 without exposing private keys to application MCU 700.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. An end-of-line production fixture platform for testing and provisioning an electronic device, comprising:
a host computer having at least one processor and memory;
a physical interface fixture having:
at least one device-under-test (DUT) bay configured to receive the electronic device;
a suite of measurement and electrical actuation peripherals associated with each DUT bay; and
a bay controller for each DUT bay configured to control the electrical actuation peripherals and implement programmable test sequences;
a test runner suite stored in the memory and executable by the processor to cause the host computer to:
execute at least one test flow on the electronic device received in the at least one DUT bay;
manage test resource allocation based on test requirements;
validate device-specific test criteria through configurable test modules; and
coordinate test operations with other fixture platforms via a network interface; and
a fixture gateway stored in the memory and executable by the processor to cause the host computer to:
implement bidirectional communication protocols for remote monitoring and configuration; and
implement secure firmware deployment.

2. The end-of-line production fixture platform of claim 1, further comprising:
a fleet manager interface configured to communicate with a fixture fleet manager to synchronize software deployment, firmware updates, and configuration across multiple fixture platforms.

3. The end-of-line production fixture platform of claim 1, wherein:
the test runner suite and the fixture gateway are implemented as containerized software components; and
the containerized software components are deployable to a fixture fleet manager for distribution to multiple fixture platforms.

4. The end-of-line production fixture platform of claim 1, wherein the physical interface fixture comprises one or more of:
a plurality of DUT bays, wherein the test runner suite is configured to implement parallel test execution across the plurality of DUT bays while maintaining independent bay-specific test flows; or
an electrical connection between control boards of the end-of-line production fixture platform and at least one additional fixture platform, enabling unified control and monitoring from the host computer across daisy-chained fixture platforms.

5. The end-of-line production fixture platform of claim 1, wherein the fixture platform is configured to electrically connect to at least one additional fixture platform via a daisy-chain interface enabling unified control from the host computer.

6. The end-of-line production fixture platform of claim 1, wherein the physical interface fixture comprises a plurality of device-under-test bays configured to implement parallel test execution across the plurality of bays while maintaining independent bay-specific test flows.

7. The end-of-line production fixture platform of claim 1, wherein the host computer is configured to execute a fixture core framework comprising a state machine for maintaining operational state and a test sequencer for executing configured test flows.

8. The end-of-line production fixture platform of claim 1, further comprising:
a provisioning and identity generation suite configured to:
derive a device identity from physically unclonable function (PUF) measurements obtained from PUF measurement circuits; and
integrate the PUF measurement circuits with tamper-sensitive structures of the electronic device such that tampering with the tamper-sensitive structures irreversibly alters the PUF measurements.

9. The end-of-line production fixture platform of claim 1, wherein the fixture platform includes a barcode tracker configured to identify devices and enable automatic association of test results with corresponding device identifiers.

10. A method of testing and provisioning the electronic device using the end-of-line production fixture platform of claim 1, comprising:
establishing communication with the electronic device via the physical interface fixture;
executing test sequences to validate device functionality;
deriving a device identity from hardware characteristics of the electronic device and establishing a hardware root-of-trust;
installing a device management service on the electronic device, wherein the device management service is configured to authenticate using the hardware root-of-trust; and
registering the device identity with a lifecycle management platform.

11. The method of claim 10, further comprising deploying a test runner agent to an external system or to the electronic device, wherein establishing communication with the electronic device is performed via the test runner agent.

12. The method of claim 10, wherein deriving the device identity comprises measuring physical characteristics of the electronic device to obtain physically unclonable function (PUF) measurements and deriving the device identity from the PUF measurements.

13. The method of claim 10, further comprising:
creating a blockchain wallet for the electronic device, wherein a private key for the blockchain wallet is derived from the hardware root-of-trust; and
recording device registration on a distributed ledger.

14. The method of claim 10, further comprising automatically selecting an active test configuration based on a barcode scanned from the electronic device.

15. An electronic device lifecycle management system, comprising:
an end-of-line production fixture platform configured to:
test electronic devices; and
provision hardware root-of-trust based device identity during manufacturing;
a fixture fleet manager configured to:
maintain network connections with a plurality of end-of-line production fixture platforms;
synchronize software deployment and configuration across the plurality of end-of-line production fixture platforms;
aggregate test results from the plurality of end-of-line production fixture platforms; and
provide a management interface for monitoring and controlling the plurality of end-of-line production fixture platforms;
a device management service installable on electronic devices, the device management service configured to:
authenticate using the hardware root-of-trust;
support verification of firmware update authenticity using the hardware root-of-trust;
support cryptographic authorization of ownership transfers; and
communicate with a secure communication network; and
the secure communication network configured to:
authenticate devices based on hardware root-of-trust derived identity;
maintain lifecycle records;
distribute firmware updates to authenticated devices; and
process end-of-life decommissioning.

16. The system of claim 15, wherein the hardware root-of-trust based device identity is derived from physically unclonable function (PUF) measurements.

17. The system of claim 16, wherein:
the device management service is further configured to support secure ownership transfer with cryptographic verification of transfer authorization and credential updates upon ownership transfer; and
the secure communication network is further configured to:
verify proper end-of-life processing based on PUF measurement capability, wherein proper disassembly of an electronic device preserves PUF measurement capability and enables access to cryptographic credentials, and improper disassembly destroys PUF measurement capability and forfeits access to said cryptographic credentials; and
distribute incentives automatically upon verified proper end-of-life processing through smart contract integration.

18. The system of claim 15, wherein the secure communication network further comprises:
a device authentication module configured to verify device identity using zero-knowledge proofs, enabling authentication without revealing the hardware root-of-trust or the device identity;
a lifecycle record system configured to maintain records of device state transitions; and
one or more of:
a firmware distribution system configured to securely deliver firmware updates to authenticated devices;
an end-of-life processing system configured to verify proper device decommissioning; or
a distributed ledger interface configured to record device attestation events on a blockchain network and verify ownership transfers through smart contract integration.

19. The system of claim 15, wherein the device management service is further configured to:
generate zero-knowledge proofs for privacy-preserving authentication with the secure communication network; and
prove device state or operational parameters without revealing underlying device identity or sensitive data.

20. The system of claim 15, wherein the software is configured to deploy containerized test runner software updates to multiple fixture platforms simultaneously via a fleet manager.
